(19) United States
(12) Patent Application Publication
(10) Pub. No.: US 2026/0104938 A1
(43) Pub. Date: Apr. 16, 2026

(54) ALLOCATING HARDWARE RESOURCES FOR NETWORK FUNCTIONS OF A NETWORK DEVICE

(71) Applicant: HEWLETT PACKARD ENTERPRISE DEVELOPMENT LP, Spring, TX (US)

(72) Inventors: Tathagata Nandy, Bangalore (IN); Somnath Bhimaram Lohar, Bangalore (IN); Venkatavaradhan Devarajan, Bangalore (IN); Rajendrakumar Devabasappanavar Kalkappa

(21) Appl. No.: 18/919,951

(22) Filed: Oct. 18, 2024

(30) Foreign Application Priority Data
Aug. 26, 2024 (IN) 202441064251

(51) Int. Cl. G06F 9/50

(52) U.S. Cl. CPC G06F 9/5044

(57) ABSTRACT

A network device may include one or more processors and a non-transitory computer-readable medium storing programming for execution by the processor(s). The network device can configure a data structure representing a virtual capacity associated with a network function. The virtual capacity can correspond to an allocation of first hardware resources of a plurality of hardware resources of the network device to the network function. The network device can monitor a demand of the network function for the plurality of hardware resources of the network device. The network device can adjust the allocation of the first hardware resources to the network function, while the network device remains operational. The allocation can be based on a capacity allocation rule and the demand of the network function. The network device can update the data structure based on the adjustment of the allocation of the first hardware resources to the network function.

### BACKGROUND

Network devices, such as routers and switches, are components of data communication networks. The network devices may direct and manage network traffic based on various network protocols and functions. Network devices may include one or more hardware resources used by the network devices to perform operations. For example, the network devices may be capable of performing one or more network functions, and may use the hardware resources to perform those network functions.

### BRIEF DESCRIPTION OF THE DRAWINGS

For a more complete understanding of this disclosure, and advantages thereof, reference is now made to the following descriptions taken in conjunction with the accompanying drawings, in which:

FIG. 1 illustrates an example computing system for allocating hardware resources for network functions of a network device, according to some implementations;

FIG. 2 illustrates additional details of an example of a network device of FIG. 1, according to some implementations;

FIG. 3 illustrates additional details of an example resource allocation system and associated components for allocating hardware resources for network functions of a network device, according to some implementations;

FIG. 4 illustrates an example method for allocating hardware resources for network functions of a network device, according to some implementations;

FIG. 5 illustrates an example method for allocating hardware resources for network functions of a network device, according to some implementations; and

FIG. 6 illustrates an example method for allocating hardware resources for network functions of a network device, according to some implementations.

### DESCRIPTION

Network devices may be used for a variety of purposes, including potentially routing and/or switching. Such network devices may be associated with network resource management of cloud systems. Network devices may be capable of performing one or more network functions, such as routing, traffic management, performance monitoring, and/or other network functions. In some implementations, the network functions may be provided by or otherwise according to one or more network protocols or other network features, such as dynamic host configuration protocol (DHCP) snooping, open shortest path first (OSPF), protocol independent multicast sparse mode (PIM SM), policy-based routing (PBR), border gateway protocol (BGP), or internet protocol (IP) service level agreement (SLA) (IP SLA), as just a few examples. The network functions may include layer 2 functions such as media access control (MAC) lookup, layer 3 functions such as IP host lookup and routing lookup, and layer 4 functions such as telemetry. The network functions may be associated with data structures (e.g., logical tables) that are abstract representations of the network functions within the device software.

A network device may include hardware resources that may be assigned or otherwise allocated to the network functions so that the network device can perform those network functions using the assigned hardware resources. The network devices may include application-specific integrated circuits (ASICs) that are configured to perform specific tasks related to network functions. As an example, ASICs may be used to perform high-speed packet processing tasks. These tasks may be performed using hardware resources (e.g., hardware resources represented by hash tables) that allow for efficient retrieval of data based on a specific “key.”

The hardware resources of the network device may be assigned up front to network functions of the network device, and the assignments may remain relatively static over time, particularly while the network device remains operational. However, network demand, such as network demand in a cloud deployment or other network environment, may fluctuate over time. The fluctuating network demand may lead to fluctuating demand for network functions of the network device, which in turn may lead to fluctuating demand by those network functions for hardware resources of the network device. The fluctuating demand may depend on various factors, such as time of day, usage patterns, or specific network events. As a result, it may be desirable for network devices to efficiently manage resources to meet the changing demands while maintaining performance and reducing costs.

In some network devices, the ASIC hash tables may be statically allocated at boot time based on a configurable profile. The configurable profile defines the allocation of resources for various network functions. However, the static allocation may not account for the dynamic nature of network traffic. The static allocation may lead to inefficiencies, as the system may not be able to adapt to changes in network demand. As a result, the typical network devices may not be able to efficiently manage changes in network demand, which may lead to potential network performance issues. To the extent such networks may be able to achieve some type of reallocation, such reallocation may involve rebooting network devices, taking them off-line and making them unable to service traffic; addition of new network devices, leading to additional capital expenditure (CapEx); and network administrator time, leading to additional operating expenditures (OpEx).

Certain implementations of this disclosure provide techniques for allocating hardware resources to network functions of network devices in a manner that is responsive to changes in network demand and that may allow the network device to remain operational (e.g., continue to service network traffic) during changes in the allocation of the hardware resources. For example, certain implementations provide a network device with a dynamic in-service elastic network configuration that can dynamically allocate hardware resources to network functions in response to fluctuating demands, while reducing or eliminating service disruptions. In certain implementations, the network device can include a dynamic resizing engine (e.g., a thick provisioning engine), a logical mapping engine (e.g., a thin provisioning engine), and an active capacity monitor. In some implementations, the network device can include a zero-touch provisioning (ZTP) module and theme-based plugins.

In some implementations, the dynamic resizing engine, which also may be referred to as a thick provisioning engine, dynamically resizes hardware tables in response to changing network demands using an ASIC or other processing device. In some implementations, the logical mapping engine, which also may be referred to as a thin provisioning engine, configures logical tables associated with the network functions, configuring placeholders for the hardware resources that are allocated based on current demand. In some implementations, the active capacity monitor adjusts resource allocation based on network demand, by, e.g., utilizing high and low watermarks for network functions to trigger allocation adjustments. In some implementations, a ZTP management module can assign a network device configuration during bootup and provide hardware and software profiles for efficient network function performance. In some implementations, the theme-based plugins can be associated with the active capacity monitor. As an example, the theme-based plugins may facilitate resource allocation decision-making based on criteria such as time of day, subscription status, or AI-based predictive models.

Certain implementations of this disclosure may provide one or more advantages. In certain implementations, the network device can dynamically allocate hardware resources to network functions based on real-time, or near-real-time, demand. In certain implementations, the dynamic resizing engine and the logical mapping engine can provide flexible allocation of hardware tables, while the active capacity monitor can intelligently adjust resource allocation based on the plugins. In some implementations, the network device can provide cost reduction by reducing over-provisioning and manual workload management.

Certain implementations may reduce or eliminate service disruption through in-service allocation adjustments. For example, certain implementations may allow the hardware resource allocations to be adjusted in response to actual network demand while allowing the network device to continue to service network traffic, with minimal-to-no interruption of service. In other words, certain implementations may allow the network device to perform in-service adjustments to resource allocation

In some implementations, the network device can provide scalability and flexibility to handle relatively unpredictable or sporadic network demands. In some implementations, the network device can provide intelligent resource management through thin and thick provisioning. Certain embodiments may provide customizable resource allocation strategies adapted to specific network environments. In some implementations, the network device can provide relatively predictable performance. As an example, thick provisioning of the hardware resources of the network device can provide relatively dedicated resources for relatively important network functions. In some implementations, the network device may maintain relatively consistent performance for applications with known resource requirements.

Certain implementations of this disclosure may reduce costs. For example, efficient resource management by a network device may lead to reduced capital expenditure (CapEx) and operational expenditure (OpEx). In some implementations, the network device may decrease the need for additional hardware procurement and manual workload management.

Certain implementations may provide customizable resource allocation. For example, the theme-based plugins of the network device may provide tailored resource allocation strategies. In some implementations, the network device may adapt to specific network environments and requirements.

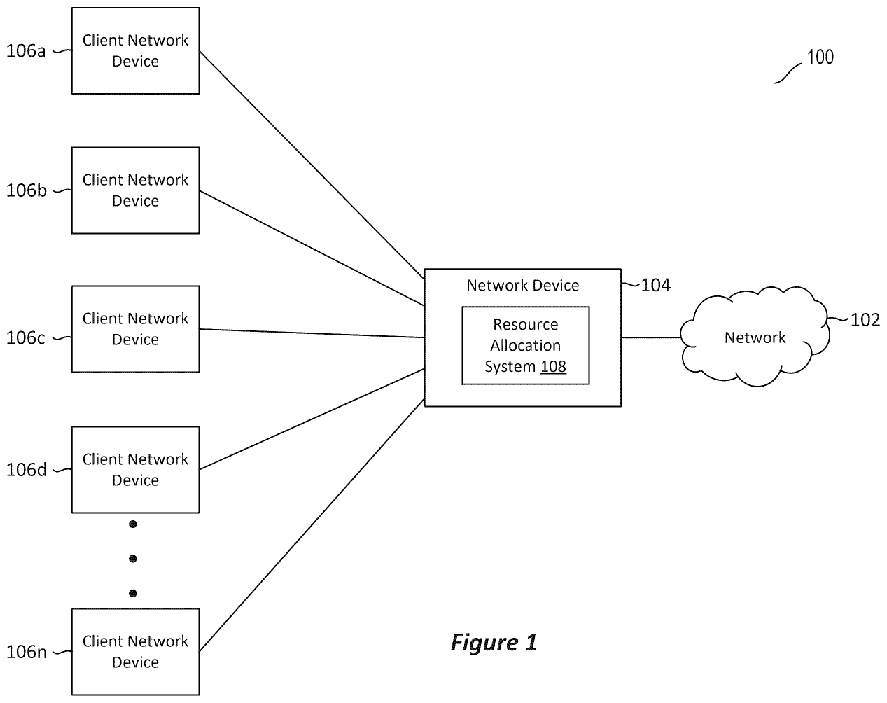

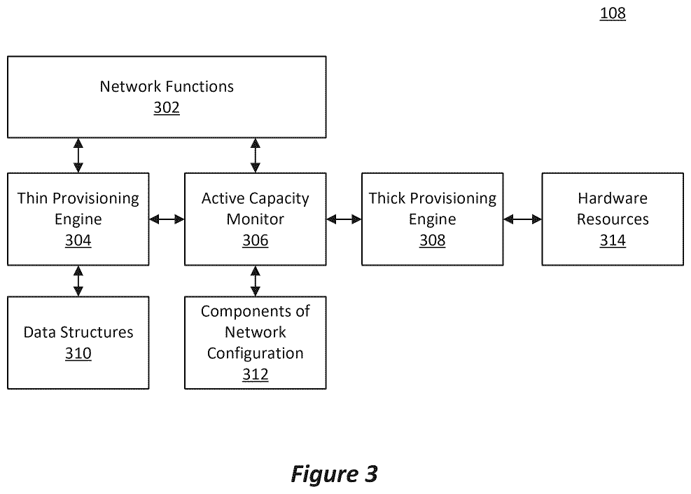

Turning to the figures, FIG. 1 illustrates an example computing system 100 for allocating hardware resources for network functions of a network device. More specifically, FIG. 1 is a block diagram of computing system 100, which may be used to allocate hardware resources (such as hardware resources 314 described below with reference to FIG. 3), according to some implementations. For purposes of this description it will be understood that “allocate” and its variants may refer generally to the process of allocating and deallocating resources, where appropriate, while in some situations it may refer simply to allocating resources.

The computing system 100 may be implemented in one or more electronic devices. Examples of electronic devices may include a range of devices that may be coupled to a network 102 or may interact with the network 102. The electronic devices may be broadly categorized into a network device 104, client devices 106, and other appropriate devices. Although FIG. 1 shows computing system 100 including a single network device 104, computing system 100 may include any suitable number of network devices 104. This disclosure also may refer to network device 104 in the singular or the plural.

The network device 104 may be a processing device that facilitates the transfer of data across the network 102. For example, the network device 104 may include a router, a switch, an access point, a firewall, a modem, or another suitable type of network device. In certain implementations, the network device 104 may direct data packets along the network 102, couple multiple devices to the network 102, manage data traffic, provide wireless connectivity, provide network security, couple networks 102 to the internet, and/or perform other suitable operations. The network device 104 may be configured to perform a range of functionalities, including those typically associated with hosts and other devices. For example, the network device 104, such as a multifunctional router, may serve as a server, hosting applications or services directly on the network device 104. In some implementations, the network device 104 may provide data routing, switching capabilities, and/or host network management software and tools. The network device 104 may perform one or more roles, thereby improving the efficiency and flexibility of network resource utilization. The network device 104 may vary in terms of their data transfer speed, range of connectivity, security features, or the specific network protocols they support.

In some implementations, the network device 104 can include a resource allocation system 108. The resource allocation system 108 operates in the network device 104 to dynamically manage hardware resources in response to changes in network demand. The resource allocation system 108 supports various network functions (such as network functions 302 described below with reference to FIG. 3), including routing, switching, access control, and security functions. The resource allocation system 108 may use hash tables in the ASIC to represent the hardware resources, which can be dynamically allocated to logical tables. The system can include plugins that facilitate resource allocation based on criteria such as running capacity, time of day, and AI predictive analytics.

The resource allocation system 108, as part of the network device 104, can manage and improve the use of the hardware resources within the network device 104. The network device 104 having the resource allocation system 108 can be communicatively coupled with various components described in FIG. 1 to provide efficient and adaptive resource allocation.

For the network device 104, which provides data transfer across the network 102, the resource allocation system 108 may dynamically allocate the hardware resources to support the network device 104 functions such as routing, switching, access control, and network security. The network device 104 can handle varying data transfer speeds, connectivity ranges, and security features without manual reconfiguration or with minimal manual configuration.

For the client devices 106, which request and use network resources, the resource allocation system 108 uses sufficient hardware resources of the network device 104, which are allocated to support operations of the client devices 106 (e.g., servers, personal computers, mobile devices, IoT devices, and other client devices). By dynamically managing the hardware resources, the resource allocation system 108 maintains improved performance and responsiveness for the client devices 106, adapting to their processing power, storage capacity, or specific applications.

The resource allocation system 108 may support the scalability of the network configuration illustrated in FIG. 1. By dynamically adjusting resource allocation based on network demand (e.g., the demand of the network functions 302), the resource allocation system 108 may provide communicative coupling of the network device 104 to an unspecified number of the client devices 106, facilitating a scalable and adaptable computing system 100. The dynamic management provided by the resource allocation system 108 maintains efficient data exchange and communication between the network device 104 and the client devices 106, allowing the computing system 100 to adapt to varying demands with little or no service interruption.

In some implementations, client devices 106a through 106n may be devices that request and use network resources. Examples of the client devices 106 include servers that host websites or applications, personal computers used by individuals or organizations, mobile devices such as smartphones and tablets, and Internet of Things (IoT) devices like smart home appliances, wearable devices, and connected vehicles.

Additional examples of the client devices 106 include storage devices such as network attached storage devices or cloud storage servers, peripheral devices, e.g., printers or scanners, that may be accessed over the network 102, and specialized devices such as security cameras or environmental sensors that send data over the network 102. In some implementations, the client devices 106 may vary in terms of their processing power, storage capacity, operating system, the specific applications they run, data types they manage, or the specific network interfaces they use.

FIG. 1 illustrates a network configuration with multiple client devices 106 interconnected through the network device 104 that is coupled to the network 102. A first client device 106a, a second client device 106b, a third client device 106c, and a fourth client device 106d are shown as being coupled to the network device 104. Additionally, an Nth client device 106n is shown, indicating the network capability to communicatively couple to an unspecified number of client devices 106, thereby representing a scalable network system. The network device 104 may be communicatively coupled to the network 102, through which data exchange and communication between the network devices (e.g., the network device 104 and one or more other network devices 104) may be performed. The computing system 100 may facilitate a dynamic communication network that may adapt to the varying demands of the coupled network device 104 and the data that the network device 104 transmits to and from the client devices 106 and the network 102.

The computing system 100 may be utilized in any data processing scenario, including stand-alone hardware, mobile applications, or combinations thereof. The computing system 100 may be used in a computing network, such as a public cloud network, a private cloud network, a hybrid cloud network, other forms of networks, or combinations thereof. As an example, the methods provided by the computing system 100 may be provided as a service over a network by, for example, a third party. The computing system 100 may be implemented on one or more hardware platforms, in which the modules in the system may be executed on one or more platforms. Such modules may run on various forms of cloud technologies and hybrid cloud technologies or be offered as a Software-as-a-Service that may be implemented on or off a cloud network.

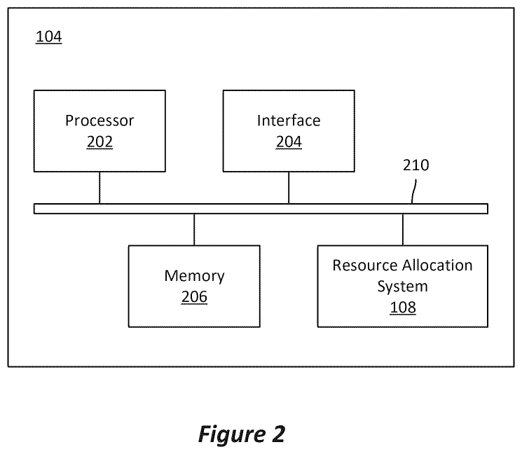

FIG. 2 illustrates additional details of an example of a network device 104 of FIG. 1, according to some implementations. In the illustrated example, network device 104 includes a processor 202, an interface 204, a memory 206, and the resource allocation system 108. The processor 202, the interface 204, the memory 206, and the resource allocation system 108 may be communicatively coupled via one or more connectors 210, which could be any suitable combination of buses and/or other types of wired or wireless connectors. In certain implementations, the connectors 210 include one or more buses, such as one or more PCI-Express buses.

The processor 202 retrieves executable code from the memory 206 and executes the executable code. The executable code may, when executed by the processor 202, cause the processor 202 to implement any functionality described herein. The processor 202 may be one or more of a microprocessor, an ASIC, a microcontroller, and/or another suitable processing component.

The memory 206 may have various types of memory, including volatile and nonvolatile memory. For example, the memory 206 may include random-access memory (RAM), read-only memory (ROM), a hard disk drive (HDD), solid-state drive (SSD), and the like. Different types of memory may be used for different data storage needs. For example, the processor 202 may boot from ROM, maintain nonvolatile storage in an HDD, execute program code stored in RAM, and store data under processing in RAM. The memory 206 may include a non-transitory computer readable medium that stores instructions for execution by the processor 202. One or more modules within the network device 104 may be partially or wholly embodied as software and/or hardware for performing any functionality described herein.

The resource allocation system 108 may operate as a component within the network device 104 that orchestrates the dynamic management of hardware resources in response to the network demand (e.g., the demand of the network functions 302). The resource allocation system 108 may be implemented using any suitable combination of software, firmware, and/or hardware. The resource allocation system 108 may operate together with the processor 202, interface 204, memory 206, and bus 210 to provide efficient and adaptive network resource allocation. In some implementations, resource allocation system 108 may be implemented at least partially as one or more software components that can be run on or by the processor 202. For example, some or all of the components of the resource allocation system 108 could be implemented as instructions stored in the non-transitory computer-readable medium of the memory 206 for execution by the processor 202 to perform some or all of the operations of the resource allocation system 108.

As described above, the resource allocation system 108 may support one or more network functions 302 that can be performed by the network device 104. Furthermore, as described above, the resource allocation system 108 may include or otherwise have access to the hardware resources 314. The hardware resources 314 may include the physical resources (such as memory, processing units, and/or networking components) that be used by the network functions 302 to perform operations associated with the network functions 302. The resource allocation system 108 may be configured to dynamically allocate hardware resources to the network functions.

The virtual capacity may refer to the maximum potential resource allocation for a network function (such as one of the network functions 302 described below with reference to FIG. 3), as represented by the logical tables in the data structures 310, which may be larger than the currently allocated hardware resources (such as hardware resources 314). The virtual capacity may allow the network device 104 to present a larger potential capacity to the control plane than what is currently allocated in the hardware resources 314.

In some implementations, the virtual capacity is a software-defined limit that represents the maximum number of entries or amount of resources a particular network function (e.g., one of the network functions 302) may potentially use, based on configuration and role of the network device 104. The virtual capacity may serve as an upper bound for potential growth and allow managing resource expectations and allocations.

As an example, for an IP routing table in the network device 104, the virtual capacity may be 1,000,000 route entries, which may be the maximum number of routes the logical table may be configured to support, based on the network device 104 role and expected demands. In some implementations, the current allocation may be 250,000 route entries, which may correspond to the actual hardware resources 314 currently allocated to store route entries. The current utilization may be 200,000 route entries, which may be the number of route entries currently in use.

In some implementations, the virtual capacity (e.g., 1,000,000 entries) represents the potential growth, which the resource allocation system 108 is prepared to handle for such network functions 302. The allocation (e.g., 250,000 entries) may represent the actual hardware resources 314 currently dedicated to the network functions 302. The resource allocation system 108 can add up to 50,000 more entries without needing to adjust the hardware resources 314.

In some implementations, if utilization approaches the current allocation, the resource allocation system 108 may allocate more hardware resources 314, up to the virtual capacity limit. The virtual capacity may allow the network device 104 to present a relatively consistent maximum capacity to the control plane, regardless of current allocations; to efficiently manage the hardware resources 314 by allocating only what is currently needed; to provide a buffer for growth without over-allocating the hardware resources 314 upfront; and/or guide decisions on when to expand or contract allocations of the hardware resources 314 based on actual usage versus potential capacity.

In some implementations, the resource allocation system 108 operates by using its software components to monitor the demand of the network functions 302 and make allocation decisions. In some implementations, the resource allocation system 108 may manage and allocate the hardware resources 314 based on the allocation decisions. In some implementations, utilizing the processor 202, memory 206, interface 204, and bus 210, the resource allocation system 108 can be configured to execute its operations and implement resource allocation.

This integrated software-hardware architecture of the resource allocation system 108 may allow for efficient and adaptive network resource allocation, which may allow the network device 104 to dynamically respond to changing network conditions by adjusting logical representations (e.g., in the data structures 310) and physical allocations (e.g., in the hardware resources 314).

As an example, the processor 202 may retrieve executable code from the memory 206 and carry out the operations commanded by the resource allocation system 108. In some implementations, when the resource allocation system 108 determines that a change in resource allocation is appropriate, e.g., based on monitoring of the demand of the network functions 302, the resource allocation system 108 transmits a signal to the processor 202, which then executes the appropriate commands to adjust the hardware resources 314.

The interface 204 allows the processor 202 to interact with various other hardware components, external from and internal to the network device 104. For example, the interface 204 may include interface(s) to input/output devices, such as, for example, a display device, a mouse, a keyboard, etc. Additionally or alternatively, the interface 204 may include interface(s) to storage devices, network devices, host devices, or other suitable interfaces.

The interface 204 may be a gateway for the processor 202 to interact with other components both within and external to the network device 104. As an example, the interface 204 provides communication between the resource allocation system 108 and other devices coupled to the network 102. The interface 204 may provide exchange of data and monitoring information that informs resource allocation decisions. For example, the interface 204 may receive signals from external network devices that affect dynamic allocation of resources, such as spikes in the demand of the network functions 302 or changes in network topology.

The memory 206 may be a repository for the data and instructions that the processor 202 uses to perform tasks, for which the processor 202 is configured. In some implementations, the memory 206 stores the programming that may include operational logic of the resource allocation system 108. As an example, the non-transitory computer-readable medium may provide the instructions for monitoring the demand of the network functions 302 and adjusting resource allocation to be accessible to the processor 202 for execution.

The bus 210 may provide a communication system that transmits data between components of the network device 104. The bus 210 may connect the processor 202, interface 204, memory 206, and resource allocation system 108, providing a flow of information between these components. Through the bus 210, the resource allocation system 108 may communicate allocation adjustments to the processor 202, which then executes the changes in real time or near real time, providing the network device 104 adaptability to fluctuating demands of the network functions 302 without substantial service interruption.

FIG. 3 illustrates additional details of an example resource allocation system and associated components for allocating the hardware resources 314 for the network functions 302 of the network device 104, according to some implementations. More specifically, FIG. 3 illustrates a block diagram of the resource allocation system 108 in the network device 104, illustrating various components that provide dynamic resource management based on the demand of the network functions 302. In some implementations, the resource allocation system 108 includes a thin provisioning engine 304, an active capacity monitor 306, and a thick provisioning engine 308, each of which may be implemented using any suitable combination of hardware, firmware, and software. In some implementations, these components of resource allocation system 108 may be implemented at least partially as software components that can be run on or by the processor 202 (see FIG. 2) and interact with other components of the network device 104.

In some implementations, the resource allocation system 108 may manage resources for the network functions 302, which may be coupled to a thin provisioning engine 304, which in turn is coupled to data structures 310. As an example, the thin provisioning engine 304 can receive information from the network functions 302 about requirements and usage related to the hardware resources 314, and in turn, provides the network functions 302 with logical resource allocations. In some implementations, the thin provisioning engine 304 can manage and update the data structures 310, reflecting the current state of logical resource allocations. In some implementations, the data structures 310 may include logical tables. The logical tables may be configured in different formats or structures. As an example, the logical tables may be configured as binary trees, linked lists, or arrays, depending on a format or structure appropriate for the network functions 302.

In some implementations, the network functions 302 may represent the various tasks that the network device 104 may be configured to perform, such as routing, switching, and access control. The network functions 302 may be associated with the data structures 310 (e.g., logical tables), which can be abstract representations of the network functions 302 within the device software. The thin provisioning engine 304 may configure logical tables of the network device 104 operating system memory. In some implementations the logical tables can be virtual tables. In some implementations, the logical tables consume minimal ASIC resources or do not consume the ASIC resources at all, thereby making the logical tables independent of the underlying ASIC resources. The logical tables may contain metadata information such as the maximum entries, minimum entries, allocated size, and references to the hardware tables that are allocated according to the demand of the network functions 302.

The logical tables may be associated with the various network functions 302 and serve as a logical representation of the hardware resources 314 allocated to each network function (e.g., one of the network functions 302). The logical tables may serve as virtual placeholders for the network functions 302 within the network device 104 software, awaiting the allocation of hardware resources 314 based on the demand of the network functions 302. A maximum capacity that the network functions 302 may support in terms of resource allocation may be represented within the network device 104 by logical tables, which are abstract constructs that define the scope of resources available for the network functions 302 without consuming physical hardware resources 314 up front.

The network functions 302 may be categorized by layers, including layer 2 functions, layer 3 functions, and layer 4 functions. As an example, the layer 2 functions may include unicast bridging and IGMP/MLD Snoop. Unicast bridging is a process that allows a switch to forward frames from one specific port to another, while IGMP/MLD Snoop is a feature that allows a layer 2 switch to observe the internet group management protocol (IGMP) and multicast listener discovery (MLD) communication between hosts and routers.

The layer 3 functions may encompass open shortest path first (OSPF), protocol independent multicast sparse mode (PIM SM), protocol independent multicast bidirectional (PIM BIDIR), and border gateway protocol (BGP). OSPF is a routing protocol for internet protocol (IP) networks, PIM SM and PIM BIDIR are multicast routing protocols that provide efficient distribution of data to multiple recipients, and BGP is a protocol that manages routing of packets across the internet through the exchange of routing and reachability information among, e.g., edge routers.

The layer 4 functions may include IP FLOW and/or telemetry. IP FLOW is a network protocol for collecting IP traffic information, while telemetry is a technology that provides the remote measurement and reporting of information of interest to the system developer or operator.

In addition to the mentioned above network functions, the network device 104 may allocate or deallocate the hardware resources 314 for other types of the network functions 302. For example, the network device 104 may allocate or deallocate the hardware resources 314 for security functions, such as firewall rules, intrusion detection systems, and virtual private networks.

The security functions can include dynamic host configuration protocol (DHCP) snooping and an IP Source Address (IP SA) validator function, which may be appropriate for certain security features, such as DHCP snooping and/or IP lockdown.

In some implementations, the security functions can include an address resolution protocol security (ARP Secure) function and/or an authorization network function. In some implementations, the security network functions can be included in layers 2, 3 and 4.

In some implementations, the network device 104 is configured to adjust the allocations of the hardware resources 314 for the network functions 302 through a series of steps performed by the resource allocation system 108. This process can include monitoring, analysis, decision making, logical allocation (e.g., of hardware resources 314), hardware resources allocation (e.g., of hardware resources 314). In some implementations, adjustment of the hardware resources 314 can include reallocation of the hardware resources 314, reconfiguration of ASIC, verification, and adaptation.

As an example, the monitoring can be performed by the active capacity monitor 306, which relatively continuously tracks the usage and demands of the network functions 302. In some implementations, the active capacity monitor 306 can collect data on current resource utilization, incoming traffic patterns, and performance metrics.

In some implementations, the active capacity monitor 306 analyzes the collected data to identify potential resource bottlenecks or underutilization. In some implementations, the active capacity monitor 306 may use artificial intelligence (AI) and/or machine learning algorithms to predict future resource needs based on historical patterns.

In some implementations, based on the analysis, the active capacity monitor 306 can determine if hardware resource allocation adjustments are appropriate. In some implementations, the active capacity monitor 306 can make such determination based on predefined thresholds (high and low watermarks) and/or allocation policies.

In some implementations, if adjustment is needed, the thin provisioning engine 304 updates the logical tables. In some implementations, such updating represents a change in the virtual capacity allocated to the specific network functions 302.

In some implementations, the thick provisioning engine 308 translates the logical allocation into hardware resource changes. In some implementations, the thick provisioning engine 308 interacts with the hardware abstraction layer to make actual adjustments to the hardware resources 314.

In some implementations, the hardware resources 314 may be reallocated among different network functions 302. Such reallocation can include expanding or contracting memory allocations, adjusting processing power, and/or modifying network interface capacities for different network functions 302.

In some aspects, the thick provisioning engine 308 may reconfigure the ASIC to reflect the new resource allocations. In some implementations, such ASIC reconfiguration can include adjusting hash table sizes and/or modifying packet processing pipelines.

In some implementations, after adjustment, the active capacity monitor 306 verifies that the changes have been successfully implemented. As an example, the active capacity monitor 306 can check whether the new resource allocation meets the intended goals without negatively impacting or only minimally impacting overall performance of the network device 104.

In some implementations, the above described adjustment process occurs relatively continuously, allowing the network device 104 to adapt to changing demands in real-time or near-real-time. For example, if the active capacity monitor 306 detects that a specific network function 302 (e.g., the IP routing function) is approaching its resource limit, the active capacity monitor 306 may trigger the thin provisioning engine 304 to update the logical table to allocate more virtual capacity to the IP routing function. In some implementations, the thick provisioning engine 308 can allocate additional physical memory to the IP routing tables. In some implementations, the thick provisioning engine 308 may adjust the ASIC configuration to provide more processing power for route lookups.

The dynamic adjustment process described herein allows the network device 104 to efficiently manage the hardware resources 314, providing the network functions 302 with the hardware resources 314 that the network functions 302 need to operate effectively under changing network conditions.

The network device 104 may be configured to adjust the hardware resources 314 for the network functions 302 related to QoS parameters. The QoS parameters may include bandwidth allocation, latency, jitter, and packet loss rate, and other suitable QoS parameters.

The network device 104 may adjust resources for the network functions 302 related to network monitoring and diagnostics. Such functions may include network traffic analysis, performance monitoring, fault detection, and troubleshooting.

The hardware tables may include physical structures implemented directly in the hardware resources 314 of the network device 104, e.g., in the ASIC or other specialized processing units. The hardware tables are used to store and relatively rapidly access network information for packet processing and forwarding decisions.

The hardware tables can provide lookup capabilities for network operations. The hardware tables can be configured to support wire-speed packet processing, providing routing, switching, and other network decisions by the network device 104 at relatively high speeds with reduced latency.

In some implementations, hardware tables may be implemented as hash tables, content-addressable memory (CAM), or ternary content-addressable memory (TCAM). The hardware tables can provide searching and matching of network data such as MAC addresses, IP addresses, access control lists (ACLs), or routing information.

The hardware tables may perform various tasks in the network device 104. As an example, forwarding information base (FIB) performed by the hardware tables can be used for storing next-hop information for packet routing. Certain implementations of the hardware tables, e.g., MAC address tables, can be used for mapping MAC addresses to switch ports for layer 2 forwarding. Certain implementations of the hardware tables, e.g., ACLs, can be used for storing rules for packet filtering and security policies. Certain implementations of the hardware tables, e.g., quality of service (QoS) tables, can be used for maintaining information for traffic prioritization and management. Certain implementations of the hardware tables, e.g., virtual local area network (VLAN) tables, can be used for storing VLAN membership information for network segmentation.

In some implementations, the ASIC (or another suitable circuitry) may include a series of hash tables, where each hash table may have different capacities ranging from, e.g., 2K to 65K. The hash tables in the ASIC can represent the hardware resources 314 available for allocation to the logical tables. The hash tables may be denoted as PV_GLOBAL_HASH_TABLE_0_65K through PV_GLOBAL_HASH_TABLE_20_2K, indicating their respective capacities. In this example, “PV” refers to a “ProVision” global resource in the network device 104. An example of the PV global resource may be PV ASIC hash tables. PV hash tables may indicate hash table slices in the hardware resources 314, which may be sliced at the boot-up operation or another suitable time. In certain implementations, hash tables reflect slices of the hardware resource 314 that may be accessible to the various network functions 302 for storing and retrieving data. The first number (zero (0) and twenty (20)) before the underscore represents an identifier and the second number (following the underscore) represents the capacity of the table in terms of the quantity of entries the hash table may process. Even though only one range is described (65K and 2K having corresponding identifiers of zero (0) and twenty (20)), any other quantity of identifiers and capacities may be implemented.

As an example, the hash tables may include the following: PV_GLOBAL_HASH_TABLE_0_65K; PV_GLOBAL_HASH_TABLE_1_65K; PV_GLOBAL_HASH_TABLE_2_65K; PV_GLOBAL_HASH_TABLE_3_65K; PV_GLOBAL_HASH_TABLE_4_32K; PV_GLOBAL_HASH_TABLE_5_32K; PV_GLOBAL_HASH_TABLE_6_32K; PV_GLOBAL_HASH_TABLE_7_32K; PV_GLOBAL_HASH_TABLE_8_16K; PV_GLOBAL_HASH_TABLE_9_16K; PV_GLOBAL_HASH_TABLE_10_8K; PV_GLOBAL_HASH_TABLE_11_8K; PV_GLOBAL_HASH_TABLE_12_8K; PV_GLOBAL_HASH_TABLE_13_8K; PV_GLOBAL_HASH_TABLE_14_8K; PV_GLOBAL_HASH_TABLE_15_4K; PV_GLOBAL_HASH_TABLE_16_4K; PV_GLOBAL_HASH_TABLE_17_4K; PV_GLOBAL_HASH_TABLE_18_4K; PV_GLOBAL_HASH_TABLE_19_2K; and PV_GLOBAL_HASH_TABLE_20_2K. It should be understood that PV hash tables are just one example of hash tables (or another suitable table) that may be used for allocating hardware resources 314. Furthermore, it should be understood that the above examples of hash table slices are just examples.

The resource allocation system 108 may include an active capacity monitor 306. The active capacity monitor 306 may be implemented using any suitable combination of software, firmware, and/or hardware. In some implementations, the active capacity monitor 306 is a software module that runs relatively continuously as part of the resource allocation system 108. In some implementations, the active capacity monitor 306 interfaces with the thin provisioning engine 304 and software components 312 (e.g., plugins) of a network configuration. The information and decisions may continue to flow to and from a thick provisioning engine 308, which may manage allocation of hardware resources 314.

In some implementations, the active capacity monitor 306 monitors the real-time or near real-time utilization of the hardware resources 314 by the various network functions 302. In some implementations, the active capacity monitor 306 analyzes resource usage patterns and the demands of the network functions 302. In some implementations, the active capacity monitor 306 makes decisions about when and how to adjust allocations of the hardware resources 314. In some implementations, the active capacity monitor 306 can be implemented as a set of algorithms and data organization that execute on or by the processor 202 of the network device 104.

In some implementations, the active capacity monitor 306 may use machine learning models for predictive analysis and decision-making. In some implementations, the active capacity monitor 306 interacts with the thin provisioning engine 304 and the thick provisioning engine 308. In some implementations, the active capacity monitor 306 receives data from various counters within the network device 104. In some implementations, the active capacity monitor 306 sends signals to initiate allocation of the hardware resources 314 when such allocation is appropriate.

In some implementations, the active capacity monitor 306 can perform real-time or near real-time monitoring, predictive analytics for anticipating resource needs, decision-making logic for triggering resource adjustments, setting and adjustment of thresholds (e.g., high and low watermarks) for resource utilization. In some implementations, the active capacity monitor 306 can be configured with different plugins or modules to modify monitoring and decision-making processes to specific network environments or requirements.

A thin provisioning engine 304 may configure the logical tables and define a maximum scale for each logical table. The thin provisioning engine 304 provides configuration of logical tables based on a configurable profile associated with a device persona. A thick provisioning engine 308 is then used to allocate hardware resources 314 to the logical tables based on current demand. The thick provisioning engine 308 provides the allocation of hardware resources 314 to the logical tables in increments, thereby providing efficient use of the hardware resources 314.

An active capacity monitor 306 may adjust the allocation of the hardware resources 314 in response to changes in the demand of the network functions 302. The active capacity monitor 306 may monitor the hardware tables and the logical tables and may adjust the hardware resources 314 accordingly. The active capacity monitor 306 may set high and low watermarks for each of the network functions 302 and adjust the allocation of the hardware resources 314 based on the high and low watermarks.

In some implementations, the thin provisioning engine 304 (or a logical mapping engine) can be a software component that may be configured to perform the initial setup of the logical tables. The thin provisioning engine 304 may configure the logical tables based on a configurable profile associated with a device persona.

In some implementations, the thin provisioning engine 304 configures the logical tables based on a configurable profile associated with a device persona. In some implementations, the device persona (e.g., “data center core router”, “‘campus edge switch”) is determined at startup or during reconfiguration. In some implementations, each persona has an associated configurable profile that defines initial resource allocation guidelines.

In some implementations, the thin provisioning engine 304 creates logical tables in software, representing different network functions 302. In some implementations, the logical tables do not consume or only minimally consume actual hardware resources 314 initially, while representing potential resource allocations.

In some implementations, for each logical table, the thin provisioning engine 304 sets various parameters such as maximum allowable entries, initial virtual capacity, growth increments, and/or priority level. In some implementations, the thin provisioning engine 304 applies specific settings from the configurable profile to each logical table.

As an example, when a device is configured with a “data center core router” persona, the configurable profile may specify the following IP routing table: 1,000,000 maximum entries; 100,000 entries for an initial virtual capacity; 50,000 entries for a growth increment; and a high priority. In some implementations, the configurable profile may specify the MAC address table as following: 100,000 maximum entries: 10,000 entries for the initial virtual capacity, 5,000 entries for the growth increment; and a medium priority. In some implementations, the ACL table can include 50,000 maximum entries; 5,000 entries for the initial virtual capacity; 1,000 entries for the growth increment; and have a high priority.

The thin provisioning engine 304 can configure the above three logical tables in software, set the parameters according to the described profile, prepare the logical tables for a potential growth up to their maximum sizes. As the network device 104 operates, these logical tables can grow or shrink within their defined parameters, while not consuming or only minimally consuming the actual hardware resources 314 until the thick provisioning engine 308 allocates the hardware resources 314 based on the actual demand.

The configurable profile of the network device 104 may be a set of parameters that define the behavior and characteristics of the network device 104, such as a router or switch. The device persona may be a configuration or role that the network device 104 assumes in a particular context or scenario. The configurable profile and the device persona facilitate configuring the logical tables, providing efficient and effective management of the network resources.

In some implementations, the configurable profile may provide the maximum scale for each logical table, which defines the scope of resources that may be allocated to each network function of the network functions 302 without consuming physical hardware resources 314 up front. The thin provisioning engine 304 provides readiness of the logical tables for being populated with entries according to the demand of the network functions 302.

In some implementations, the thin provisioning engine 304 prepares the logical tables for potential addition of entries according to the demand of the network functions 302. In some implementations, the thin provisioning engine 304 creates empty data structures 310 in software to represent each logical table. In some implementations, the thin provisioning engine 304 configures metadata for each logical table, including, for example, maximum capacity (e.g., maximum number of entries the table could potentially hold), current virtual capacity (e.g., the current size limit, which can be adjusted dynamically), growth parameters (e.g., how much to expand the logical table when the logical table reaches capacity), and/or performance thresholds (e.g., load factors, which trigger expansion).

In some implementations, the thin provisioning engine 304 creates software interfaces that allow other components of the resource allocation system 108 (such as the active capacity monitor 306) to interact with the logical tables. The interfaces may include methods for adding, removing, and/or querying entries. In some implementations, the thin provisioning engine 304 implements the logic for dynamically expanding the logical tables when it is appropriate. As an example, the thin provisioning engine 304 can utilize methods for requesting additional hardware resources 314 from the thick provisioning engine 308 when the logical table needs to grow.

In some implementations, the thin provisioning engine 304 establishes connections with the active capacity monitor 306 to track usage and performance of each logical table. In some implementations, the thin provisioning engine 304 sets up frameworks to track the current state of each logical table, including a number of entries, utilization percentage, etc. In some implementations, the thin provisioning engine 304 implements prioritization logic that determines how different logical tables compete for the hardware resources 314 when the network device 104 experiences a constraint of the hardware resources 314.

As an example, for an IP routing table, the thin provisioning engine 304 may initialize an empty logical table to represent the logical IP routing table. In some implementations, the thin provisioning engine 304 may set the maximum capacity to 1,000,000 entries, but start with a virtual capacity of 100,000 entries. In some implementations, the thin provisioning engine 304 may configure the data structure representing the logical IP routing table to grow in increments of 50,000 entries when the data structure reaches 80 percent capacity.

In some implementations, the thin provisioning engine 304 may establish methods for adding and looking up routes that other components of the network device 104 (e.g., the resource allocation system 108) can use. In some implementations, the thin provisioning engine 304 can set up tracking to monitor how many entries may be currently in use and how quickly the data structure representing the logical IP routing table may be growing. In some implementations, the thin provisioning engine 304 can prepare logic to request more resources from the thick provisioning engine 308 when it is appropriate for the logical IP routing table to expand.

In some implementations, the above preparation allows the logical table to appear to the rest of the network device 104 as if it has a large capacity, while actually consuming minimal hardware resources 314 until entries are actually added to the logical tables. The logical table may be ready to grow dynamically as the demand of the network functions 302 increases.

The configurable profile may be selected from a library of configurable profiles, where each configurable profile may be associated with a different device persona. As an example, a “data center core router” profile may include the following: an IP routing table having an initial capacity of 1,000,000 entries, a high watermark of 80 percent, and a low watermark of 40 percent; a BGP table having an initial capacity of 500,000 entries, a high watermark of 75 percent, and a low watermark of 50 percent; an ACL table having an initial capacity of 50,000 entries, a high watermark of 90 percent, and a low watermark of 60 percent; and a QoS table having an initial capacity of 10,000 entries, a high watermark of 85 percent, and a low watermark of 55 percent. In some implementations, the resource allocation priority may be the following: the IP routing table being above the BGP table, which is above the ACL table, which is above the QoS table.

In some implementations, an “enterprise edge switch” profile may include a MAC address table having an initial capacity of 32,000 entries, a high watermark of 75 percent, and a low watermark of 35 percent; an IP host table having an initial capacity of 16,000 entries, a high watermark of 80 percent, and a low watermark of 40 percent; an ACL table having an initial capacity of 5,000 entries, a high watermark 85 percent, and a low watermark 50 percent; and the NAT table having an initial capacity 10,000 entries, a high watermark 90 percent, and a low watermark 60 percent. In some implementations, the resource allocation priority may be the following: the ACL table being above the MAC address table, which is above the IP host table, which is above the NAT table.

In some implementations, a “campus access switch” profile can include a MAC address table having an initial capacity of 8,000 entries, a high watermark of 70 percent, and a low watermark of 30 percent; an IP host table having an initial capacity of 4,000 entries, a high watermark of 75 percent, and a low watermark of 35 percent; a user authentication table having an initial capacity of 1,000 entries, a high watermark of 90 percent, and a low watermark 50 percent; and a QoS table having an initial capacity of 1,000 entries, a high watermark of 85 percent, and a low watermark of 45 percent. In some implementations, the resource allocation priority may be the following: the user authentication table being above the MAC address table, which is above the QoS table, which is above the IP host table.

In some implementations, a “service provider edge router” profile may include the following: an IP routing table having an initial capacity of 2,000,000 entries, a high watermark of 85 percent, and a low watermark of 55 percent; a multiprotocol label switching (MPLS) table having an initial capacity of 100,000 entries, a high watermark of 80 percent, and a low watermark of 50 percent; a virtual routing and forwarding (VRF) table having an initial capacity of 1,000 entries, a high watermark of 90 percent, and a low watermark of 70 percent; and a QoS table having an initial capacity of 50,000 entries, a high watermark of 85 percent, and a low watermark of 55 percent. In some implementations, the resource allocation priority may be the following: the IP routing table being above the MPLS table, which is above the VRF table, which is above the QoS table.

In some implementations, an “IoT gateway” profile may include a device identity table having an initial capacity of 100,000 entries, a high watermark of 85 percent, and a low watermark of 45 percent; an IP host table having an initial capacity of 50,000 entries, a high watermark of 80 percent, and a low watermark of 40 percent; a security policy table having an initial capacity of 10,000 entries, a high watermark of 90 percent, and a low watermark of 60 percent; and a data aggregation table having an initial capacity of 20,000 entries, a high watermark of 75 percent, and a low watermark of 35 percent. In some implementations, the resource allocation priority may be the following: the security policy table being above the device identity table, which is above the IP host table, which is above the data aggregation table.

Each configurable profile may be tailored to the expected needs of the network device 104 in its specific role, allowing for efficient initial resource allocation and setting appropriate thresholds for dynamic adjustments. Such selection of the configurable profile may provide a fast configuration of the data structures 310 to be appropriate for a variety of device personae.

In some implementations, the configurable profile may be customized by a network administrator or another user to create a profile that is tailored to the specific requirements of a particular device persona. Such customization of the configurable profile may provide flexibility and adaptability in the configuration of the data structures 310.

The configurable profile may be dynamically adjusted based on real time or near real time network conditions and performance metrics. Such dynamic adjustment of the configurable profile may provide adaptability to the data structures 310 for changing demands of the network functions 302 and improving resource allocation.

As an example, if the network device 104 is initially configured with a “campus edge switch” profile, the initial configurable profile may include the following: a MAC address table, an ACL table, and an IP host table. The MAC address table can be configured to have 32,000 maximum entries; 8,000 entries for an initial virtual capacity; and 2,000 entries for a growth increment. The ACL table can be configured for 2,000 maximum entries; 500 entries for the initial virtual capacity; and 100 entries for the growth increment. The IP host table can be configured for 16,000 maximum entries; 4,000 entries for the initial virtual capacity; and 1,000 entries for the growth increment.

If the network experiences a substantial change, according to some embodiments (e.g., a large number of IoT devices are added to the campus network), the network device 104 may have the following conditions and metrics: MAC address table utilization consistently above 90 percent for 24 hours; IP host table utilization spiking to 85 percent during peak hours; and/or ACL table utilization remaining relatively steady at around 30 percent.

Based on such conditions, the resource allocation system 108 can dynamically adjust the configurable profile as follows. In some implementations, an updated configuration for the MAC address table can include the following: maximum entries may be increased to 64,000 (e.g., doubled), the initial virtual capacity may be increased to 16,000 entries; and the growth increment may be increased to 4,000 entries. In some implementations, the ACL table updated configuration may include the following: maximum entries may be reduced to 1,500; the initial virtual capacity may be reduced to 300 entries; the growth increment may remain unchanged at 100 entries. In some implementations, the IP host table updated configuration may include maximum entries being increased to 32,000. In some implementations, the initial virtual capacity can be increased to 8,000 entries. In some implementations, the growth increment can be increased to 2,000 entries.

As illustrated herein the resource allocation system 108 identifies the sustained high utilization of the MAC address table and increases the capacity of the MAC address table to accommodate the influx demand exhibited by, e.g., new devices. The IP host table also may be expanded based on the observed peak usage patterns. The hardware resources 314 may be reallocated from the underutilized ACL table to support the growth of other tables. In some implementations, the thin provisioning engine 304 may apply such changes to the data structures 310. In some implementations, the thin provisioning engine 304 updates the metadata for each table (e.g., the MAC address table, the IP host table, and/or ACL table) to reflect the new maximum entries and growth parameters. In some implementations, the thin provisioning engine 304 prepares the MAC address and IP host tables for potential rapid growth by adjusting their expansion mechanisms. In some implementations, the thin provisioning engine 304 modifies the prioritization logic to provide a higher priority to MAC address and IP host table growth.

The dynamic adjustment allows the network device to adapt to the changing network environment, relatively efficiently allocating the hardware resources 314 where they are appropriate based on observed usage patterns.

The thin provisioning engine 304 initially configures logical tables based on the device persona and configurable profile. This initial configuration sets up the initial state of allocation for each logical table. However, this allocation may be not static and can change over time based on the demand of the network functions 302. In some implementations, allocation for a particular logical table can change over time, e.g., a different time period can have a different state of allocation. For example, different time periods can have different states of allocation based on varying demands of the network functions 302. This dynamic nature allows the resource allocation system 108 to adapt to changing network requirements.

An “instance” can refer to a specific state of a logical table within the network device 104. The state may be defined by configuration and/or allocation. In some implementations, the configuration may refer to the setup and parameters of the logical table. In some implementations, the configuration can include the table structure (e.g., a tree structure), maximum capacity, performance thresholds, growth parameters, and/or associated network functions 302.

In some implementations, the allocation may refer to the actual assignment of hardware resources 314 to the logical table. In some implementations, the allocation may include the amount of memory currently reserved for the table, any dedicated processing resources, and/or the current number of entries the table can hold.

In some implementations, after the thin provisioning engine 304 configures the logical table based on the device persona and the configurable profile, the thick provisioning engine 308 may allocate actual hardware resources 314 to the logical table based on the current demand and the configuration set by the thin provisioning engine 304.

Each instance can represent a set of hardware resources 314 that have been allocated for a particular network function of the network functions 302 at a given time. For example, an IP flow logical table instance can represent a portion of the hardware resources 314 that is configured to hold IP flow entries, such as routing information or packet forwarding rules.

Instances can be dynamic and can be adjusted in size and number based on the demand of the network functions 302. The control plane software can create, modify, or delete instances of logical tables as traffic patterns change. In some implementations, the network device 104 can efficiently manage the hardware resources 314 and maintain performance with minimal or no manual reconfiguration and hardware changes.

The network device 104 can maintain one or more instances of a logical table for IP flow processing at a given point in time. In some implementations, each instance represents a specific allocation of hardware resources 314 dedicated to handling IP flow entries, such as routing information or packet forwarding rules. These instances reflect the current resource requirements based on traffic patterns and the demands of the network functions 302.

For example, the network device 104 may have a primary IP flow logical table instance allocated with resources to handle 10,000 entries during normal operation. During periods of high traffic, an additional instance may be created and resources may be allocated to handle another 5,000 entries. Each of these instances corresponds to a portion of the hardware resources 314 configured to manage IP flow data. The number and size of these instances can be dynamically adjusted by the resource allocation system 108 based on current network conditions.

As the demand of the IP flow network function changes, the logical table for IP flow can be resized to accommodate more or fewer entries, with the control plane software adjusting the allocation in the hardware resources 314 accordingly. The entries may be the specific data records stored in the logical tables and hash tables. The entries may include information such as source and destination IP addresses; source and destination ports; a protocol type; flow statistics (e.g., packet count, byte count); timing information (e.g., flow start and end times); and/or routing information associated with the flow. The entries may include information related to the various network functions 302, such as MAC addresses, IP addresses, VLAN identifiers, and other network parameters. The entries may be used by the network device 104 to perform various network operations, such as routing, switching, and access control. The entries may be dynamically managed by the resource allocation system 108, with new entries being added (or existing entries being updated or deleted) in response to changes in the demand of the network functions 302.

In some implementations, in response to the increasing demand of the network functions 302 (e.g., the IP flow function), the resource allocation system 108 may perform adjustments in the following manner. The thin provisioning engine 304 may update the logical table configuration to allow for more entries. The thick provisioning engine 308 may then allocate additional memory in the hardware resources 314 to store these extra IP flow records. The control plane software can update its data structures and processing logic to manage the enlarged table. Conversely, if demand decreases, the resource allocation system 108 can reduce the size of the logical table, deallocating unused hardware resources 314 to make them available for other network functions 302.

The resizing of the logical tables is a dynamic process that adjusts the logical table capacity based on current and the anticipated demand of the network functions 302. This process is based on the number of “entries” included in the logical table, where “entries” refer to specific data records relevant to the table function (e.g., one of the network functions 302).

The nature of these entries varies depending on the type of the logical table. As an example, for an IP routing table, the entries may be individual route entries (e.g., destination IP, next hop, metrics, etc.). As an example, for a MAC address table, the entries may be a MAC address to port mappings. As an example, for the ACL table, the entries may be individual ACL rules.

In some implementations, the resizing process may include, e.g., monitoring, threshold evaluation, capacity adjustment, resource allocation, and, optionally, table reconstruction. In some implementations, the active capacity monitor 306 tracks the number of entries in each logical table and the rate of growth. In some implementations, when the number of entries reaches a predefined threshold (e.g., 80 percent of current capacity), the resizing process is triggered. In some implementations, the thin provisioning engine 304 increases the logical table virtual capacity, for example, from 10,000 to 15,000 entries. In some implementations, the thick provisioning engine 308 allocates additional hardware resources 314 to support the increased capacity, such as more memory for storing the entries. In some implementations, the resource allocation system 108 may rebuild the table structure (e.g., resizing a hash table) to accommodate the new capacity efficiently.

In some implementations, the resource allocation system 108 may use techniques like gradual migration, where a new, larger table is constructed alongside the existing one, and entries are gradually moved over. In some implementations, during the resizing process, incoming packets are processed using both the old and new tables to ensure no traffic or only minimal traffic is dropped. In some implementations, when migration is complete, the resource allocation system 108 switches over to the new table entirely or substantially entirely.

As an example, for an IP routing table, the initial state may be defined by the logical table configured for 10,000 route entries, currently containing 8,000 entries. In some implementations, as the table reaches 8,000 entries (80 percent threshold), resizing is triggered. The thin provisioning engine 304 may increase the logical capacity to 15,000 entries. In some implementations, the thick provisioning engine 308 allocates additional memory to support 5,000 more entries. A new table structure may be created to hold 15,000 entries. Existing 8,000 entries may be gradually copied to the new structure. In some implementations, during migration, route lookups check both old and new tables. When migration is complete, the old table may be deallocated, and all operations use the new, larger table.

The resizing of the logical tables can be performed with little or no service disruption, providing adaptability to the network to accommodate varying loads and improve the utilization of the hardware resources 314.

The ability to have multiple instances of the logical table, each instance with potentially different sizes, can represent the elasticity of the hardware resources 314 of the network device 104. In some implementations, the logical table is not fixed in size and can be expanded or contracted as appropriate for the real-time demands for the hardware resources 314.

The device persona is a component, which may be used in the initial configuration and ongoing adjustment of resource allocation within the network device 104. In some implementations, the device persona serves as a high-level abstraction that informs the resource allocation system 108 about the expected role and demands of the network device 104.

In some implementations, when the network device 104 boots up or is reconfigured, the thin provisioning engine 304 uses the device persona to set initial parameters for logical tables. For example, a “data center core router” persona may prioritize large IP routing and BGP tables. In some implementations, a “campus edge switch” persona may allocate more resources to MAC address and access control list tables.

In some implementations, the active capacity monitor 306 uses the device persona to set appropriate thresholds for triggering resource adjustments. As an example, a “high-performance computing cluster switch” persona may set lower utilization thresholds to trigger resource expansion, allowing a reduced latency. In some implementations, an “IoT gateway” persona may set higher thresholds, anticipating relatively more sporadic traffic patterns.

In some implementations, the resource allocation system 108 uses the device persona to prioritize different network functions 302 when hardware resources 314 are constrained. For example, a “security appliance” persona may prioritize resources for a relatively deep packet inspection and threat detection functions. In some implementations, a “wireless controller” persona may prioritize hardware resources 314 for client authentication and mobility management.

In some implementations, the device persona can be dynamically selected or adjusted based on various factors. As an example, in a multi-tenant environment, the network device 104 may switch between different personas based on which user group is most active, adjusting resource allocation to match the specific needs of each group. In some implementations, the network device 104 may adopt different personas based on the dominant application traffic, e.g., switching to a “video optimization” persona during periods of high streaming activity.

In some implementations, the network device 104 may switch from an “access layer” persona to a “distribution layer” persona if the resource allocation system 108 detects changes in a topological position of the network device 104, adjusting resource allocation accordingly. In some implementations, the network device 104 may switch to a “backup and maintenance” persona during off-hours, allocating more hardware resources 314 to management and data transfer functions. In some implementations, during periods of high traffic, the network device 104 may adopt a “high-throughput” persona, prioritizing packet forwarding resources over other functions.

The resource allocation system 108 may relatively continuously monitor the effectiveness of resource allocations based on the current persona. This data may be used to refine and optimize persona definitions over time, improving the efficiency of future resource allocations.

In some implementations, the network device 104 initially boots with a “general-purpose switch” persona. As the network device 104 detects a high volume of voice and video traffic during business hours, the network device 104 may dynamically shift to a “unified communications optimized” persona. In some implementations, based on this change of the device persona, the thin provisioning engine 304 adjusts logical table configurations to allocate more resources to QoS and media flow tables. The active capacity monitor 306 may adjust its thresholds to be more sensitive to jitter and latency metrics. The thick provisioning engine 308 may reallocate the hardware resources 314 to prioritize real-time packet processing. By dynamically adapting the device persona, the network device 104 optimizes the resource allocation to provide better support for the observed unified communications traffic, improving overall network performance for these applications.

In some implementations, source group lookup (S_G_LOOKUP) table and the star group lookup (STAR_G_LOOKUP) table may be utilized by the network device 104 to allocate the hardware resources 314. The S_G_LOOKUP table refers to a multicast routing entry for a specific source and a multicast group pair. The STAR_G_LOOKUP refers to a multicast routing entry for any source to a specific multicast group.

In some implementations, the logical table for the network function (e.g., one of the network functions 302), such as the S_G_LOOKUP, may be initially set with a maximum capacity based on the device persona. If the network device 104 is operating in a protocol independent multicast sparse mode (PIM SM) or protocol independent multicast bidirectional (PIM BIDIR) personae, the S_G_LOOKUP table may be allocated with 8K entries and the STAR_G_LOOKUP table may be allocated with zero (0) entries. In a persona having both PIM BIDIR and PIM SM personae (e.g., a MIXED persona), both S_G_LOOKUP and STAR_G_LOOKUP tables may be allocated 4K entries per each table, providing the total number of entries not to exceed the device persona limits. Such dynamic resizing capability provides the network functions 302 that remain operational without consuming additional ASIC resources or only minimally consuming the additional ASIC resources.

The active capacity monitor 306 may be a monitoring component that observes in real time or near real time the demand of the network functions 302 and utilization of the logical tables. The active capacity monitor 306 may utilize thresholds, such as high and low watermarks, to make informed decisions about the time when to allocate or deallocate hardware resources 314 to the logical tables. The active capacity monitor 306 is the decision-making engine that dynamically adjusts resource allocation in real time or near real time, providing responsiveness to the network device 104 with respect to fluctuating demands of the network functions 302 without service interruption or with minimal service interruption.

The active capacity monitor 306 may have a plugin-based configuration that provides the active capacity monitor 306 with various plugins. As an example, software components 312 of the network configuration, which may include plugins, interface with the active capacity monitor 306. The plugins may be configured to dynamically adjust the allocation of hardware resources 314 based on various criteria and demands.

As an example, the plugins may be theme-based and can be configured to facilitate the allocation and deallocation of hardware resources 314 based on a variety of criteria, such as running capacity, time of day, subscription based (e.g., service agreement), and AI predictive analytics. Each plugin may have its own set of configurations that may contribute to the dynamic allocation of the hardware resources 314. The plugins may provide a layer of intelligence and adaptability for the resource allocation system 108, providing a resource management having context-awareness.

For example, the running capacity plugin may monitor the rate at which entries of the network functions 302 are learned and generate appropriate data such as high and low watermarks. Based on the high and low watermarks, the allocation of resources is initiated when the high watermark is reached, such that the network functions 302 remain operational during a relatively high peak demand. The hardware resources 314 are released when the demand of the network functions 302 is relatively low, as indicated by the low watermark. Even though only two watermarks (or thresholds) are described, e.g., the high watermark and the low watermark, any other quantity of watermarks may be implemented, for example, three, four, five, or any other appropriate number of the watermarks suitable for the running capacity plugin of the network device 104.

In some implementations, the running capacity plugin manages the MAC address table for a network switch. As an example, during the initial configuration, a current MAC address table capacity may require 16,000 entries; a learning rate measurement interval may be five minutes; the high watermark may be 80 percent of current capacity (12,800 entries); and the low watermark may be 40 percent of current capacity (6,400 entries).

The plugin may monitor in real time or near real time the rate at which new MAC addresses are learned. The “learning rate” may refer to the rate at which new unique MAC addresses are added to the MAC address table. As an example, over a five-minute interval, the plugin observes the following: a starting entry count of 10,000; an ending entry count of 11,500; net new entries of 1,500; and the learning rate of 300 entries per minute.

Based on such learning rate, the plugin projects that the table may reach capacity in approximately 15 minutes (dividing by 300 a difference between 16,000 and 11,500). As the entry count reaches 12,800 (e.g., the high watermark), the plugin triggers a resource allocation action.

In some implementations, the thick provisioning engine 308 is signaled to increase the MAC address table capacity. As an example, the capacity can be increased by 50 percent to 24,000 entries. In some implementations, new watermarks are calculated: e.g., the new high watermark of 19,200 entries (e.g., 80 percent of 24,000) and the new low watermark of 9,600 entries (e.g., 40 percent of 24,000).

In some implementations, if network activity decreases and the entry count drops to 9,600 (e.g., the new low watermark), the plugin monitors for a sustained period (e.g., 30 minutes) to confirm it is not a temporary fluctuation. If the low usage persists, the plugin may trigger a deallocation action, during which the capacity of the MAC address table is reduced by 25 percent to 18,000 entries and the watermarks are recalculated to provide, e.g., the new high watermark of 14,400 and the new low watermark of 7,200 entries.

The active capacity monitor 306 of the network device 104 may include a resource management procedure that identifies and separates a subset of the hardware resources 314 to form a staging pool, which is separate from a current allocation of the hardware resources 314. The staging pool is reserved for reorganization tasks, such as compaction and defragmentation, to provide non-interference or slight interference of the reorganization tasks with the primary network functions 302.

For example, the resource management procedure may allocate ten percent of the total hardware resources 314 to the staging pool. In some implementations, the active capacity monitor 306 in real time or near real time tracks the fragmentation level of the allocated resources. When fragmentation exceeds a threshold (e.g., 30 percent), the procedure may initiate a reorganization task. In some implementations, the resource allocation system 108 uses the staging pool to perform the reorganization. As an example, the data may be copied from fragmented areas of the main allocation to the staging pool. In some implementations, this data is reorganized in the staging pool for an improved arrangement. In some implementations, the reorganized data is copied back to the main allocation, reducing fragmentation.

In some implementations, during the reorganization process, the firmware and/or software logic allows important network functions 302 to maintain priority access to the hardware resources 314. As an example, if a high-priority function (e.g., a core routing function) needs the hardware resources 314 during reorganization, the high-priority function can temporarily borrow the hardware resources 314 from the staging pool. In some implementations, the reorganization task may yield to the high-priority function, allowing a relative continuity of important network services.

In some implementations, when the reorganization is complete, the staging pool is cleared and ready for the next task. Such approach may allow the network device 104 to maintain an improved resource organization and efficiency while reducing disruption to ongoing network operations.

The hardware slices of the hardware resources 314 can be independently attached or detached to a logical table. In certain implementations, a logical table may be inactive if it is not attached to any logical network functions 302. In some implementations, the active capacity monitor 306 includes reservation of one hardware slice from a pool that includes, e.g., 2K-entry and 4K-entry capacities, for compaction and defragmentation purposes, which are reserved staging slices, in which the active capacity monitor 306 may copy entries when there are no unallocated free slices. The staging slices used for compaction and defragmentation are not enabled for hardware lookup and when all entries are staged, the module triggers the linking phase. The linking phase may convert the lookup from the active tables to the staged tables making the swapped-out table inactive. As an example, the staged table may be prefilled with the required entries and swapped making such staged table active and the swapped-out table inactive. The compaction and defragmentation functions of the active capacity monitor 306 may be described as in-service, with little-to-no impact on ongoing network functions 302 and traffic.

The network device 104 may feature a modular architecture that provides the integration of various plugin modules configured to manage resource allocation during the reorganization process. As an example, a plugin module may be configured to manage the staging pool by initiating the linking phase under certain conditions. The conditions triggering the linking phase may be configured by the network administrator and may include parameters such as the demand of the network functions 302spikes, scheduled maintenance times, or the occurrence of network events when reorganization of table entries is appropriate. The plugin module configured to manage allocation of resources during the reorganization process may operate together with the active capacity monitor 306 to provide a relatively seamless transition during the reorganization process.

The active capacity monitor 306 may utilize analytics and machine learning algorithms that analyze historical network usage data to predict future demand patterns. The predictive capability of the active capacity monitor 306 provides a capability to the network device 104 to dynamically adjust the size of the staging pool, providing availability of appropriate resources to manage anticipated network loads and reorganization tasks. The predictive models of the network device 104 are refined in real time or near real time based on data obtained in real time or near real time, improving the accuracy of forecasts and the efficiency of resource allocation.

The active capacity monitor 306 may be configured to manage complex network environments where potentially simultaneous reorganization operations may be appropriate. For example, the network device 104 may support the management of multiple staging pools, where each staging pool is dedicated to a specific set of table entries or reorganization tasks. This multi-pool management capability provides parallel processing, which may provide reduction of time taken for multiple reorganization processes. The active capacity monitor 306 coordinates the activities of each staging pool, providing improvement to hardware resources 314 across the network device 104.

The network device 104 may be integrated with a network management system that provides oversight and control over network resources. The active capacity monitor 306 may be configured to communicate with the network management system, providing timely notifications about the status of reorganization processes. The notifications may include alerts at the commencement of reorganization, updates on progress, and confirmations upon completion. The notifications may provide network administrators with up-to-date information so that the network administrators may make data-driven decisions to maintain network performance and integrity.

Following configuration of logical tables, hardware resources 314 are allocated to the logical tables based on the current demand. The thick provisioning engine 308 is the component of the resource allocation system 108 that implements the decisions made by the active capacity monitor 306. The thick provisioning engine 308 may allocate or deallocate physical resources from the hardware resources 314 to the logical tables when the active capacity monitor 306 detects that the demand of the network functions 302has crossed the threshold, e.g., the high watermark or the low watermark, respectively. The thick provisioning engine 308 may incrementally allocate or deallocate the hardware resources 314, which provides a granular and efficient use of the hardware resources 314.

Thick provisioning may include the actual allocation of RAM in the ASIC to the logical tables based on the current demand. The thick provisioning engine 308 is configured to attach (expand or allocate) and detach (shrink or deallocate) physical tables from the logical tables. The implementation of thick provisioning may be appropriate for a software development kit, which may provide bulk update APIs, such as copy, attach, de-attach, and delete functions.

As an example, if additional entries are appropriate for the logical table S_G_LOOKUP due to an increased demand, the thick provisioning engine 308 may allocate additional slices from the hardware resources 314 to expand the hash table capacity in the ASIC. If the demand decreases, the thick provisioning engine 308 may detach the hardware slices, reducing the hash table capacity.

The data structures 310 (which may include logical tables) serve as a virtual capacity representation for the network functions 302. The data structures 310 are data constructs that correspond to the allocation of first hardware resources from the hardware resources 314 to the network functions 302. The data structures 310 can be dynamically updated to reflect the current state of allocation of the hardware resources 314. The data structures 310 provide the network device 104 a capability to maintain an accurate view of utilization of the hardware resources 314.

The logical tables may include one or more logical tables for multicast source-specific join (MCAST_S_G), one or more logical tables for multicast shared tree join (MCAST_STAR_G), one or more logical tables for unicast host route (UCAST_HOST), one or more logical tables for unicast longest prefix match (UCAST_LPM), one or more logical tables for MAC source address (MAC_SA), one or more logical tables for MAC destination address (MAC_DA), one or more logical tables for IP_FLOW, and/or any other suitable types of logical tables. The logical tables of the in-service elastic network device 104 may be configured automatically by the operating system of the network device 104. The process of configuring the logical tables is managed by the thin provisioning engine 304, which may be an integral or separate part of software framework of the network device 104 configured to dynamically manage the hardware resources 314.

During the bootup sequence of the network device 104, the operating system may automatically configure logical tables based on the device persona or a configurable profile. The logical tables may be coupled to plugins (e.g., to the AI predictive model, time of day, subscription, running capacity, and other suitable plugins). The logical tables are virtual and exist in the operating system memory of the network device 104. In some implementations, the logical tables at the bootup process may consume minimal ASIC resources or no ASIC resources at all.

The thin provisioning engine 304 may configure the logical tables by, e.g., defining the maximum addressable capacity for each network function of the network functions 302 (such as unicast host lookup or multicast source group lookup) without allocating physical hardware resources 314 to the network functions 302 up front.

The active capacity monitor 306 monitors the demand of the network functions 302 and utilization of the logical tables. The active capacity monitor 306 may utilize the watermarks (or thresholds) to determine when to dynamically allocate or deallocate hardware resources 314 to the logical tables.

In some implementations, some events, such as a host lookup miss, may trigger the allocation of hardware resources to a logical table to accommodate new demands of the network functions 302.

The network device 104 may use plugins for decision-making, which may be based on various themes, e.g., plugins based on a period of time, e.g., time-of-day services, or AI-driven predictive models. The plugins may facilitate the automatic adjustment of logical table sizes.

In some implementations, users may manually configure the logical tables. In some implementations, the logical tables are automatically configured and managed by the operating system of the network device 104 and its associated components. The elastic network device 104 may be configured to be adaptable to changing demands without manual intervention or with minimal manual intervention, thereby reducing capital expenditures and operational expenditures for cloud providers.

The resource allocation system 108 shown in FIG. 3 may provide a framework that may configure the network device 104 to dynamically manage the hardware resources 314 in response to real time or near real time demand of the network functions 302. The resource allocation system 108 may reduce the likelihood of service disruptions and inefficiencies associated with static resource allocation, thereby improving capital and operational expenditures.

As an example, the network device 104 may include, e.g., 8K multicast entries and 64K host entries. These entries may represent slices of the hardware tables that may be dynamically allocated to different logical tables based on the demand of the network functions 302. For example, at the initial bootup of the network device 104, the hardware resources 314 may be allocated to any specific network function of the network functions 302.

When the network 102 (see FIG. 1) begins to operate and hosts start to couple, the network device 104 detects the new hosts (which can be client devices 106) when, e.g., a host lookup miss event occurs. In response, the network device 104 allocates some hardware resources 314 to accommodate these new hosts. For example, if 4K slices are allocated to the “unicast host lookup” logical table, 4K out of the 64K available host entries may be allocated to the unicast host lookup functions.

As the network 102 continues to operate, if the network device 104 detects multicast traffic from services such as simple service discovery protocol (SSDP), the network device 104 may allocate resources to manage this traffic. For example, the network device 104 may allocate 8K slices to the “multicast source group lookup table” to manage multicast traffic lookup functions.

In some networks 102, each dual-stack host may require two multicast entries to support the SSDP services. Therefore, with 8K multicast entries available, the network device in such networks may support 4K dual-stack hosts. In the network device 104 that has an elastic network configuration, the remaining free 60K host entries (the initial 4K allocated for unicast are subtracted from the 64K total entries) may be shared between multicast and host tables.

The sharing capability allows the network 102 to service additional hosts beyond the initial allocation. For example, if each SSDP host requires one multicast entry, the remaining 60K entries may potentially service up to 60K additional SSDP hosts. If it is appropriate for each SSDP host to have two multicast entries, as in the dual-stack scenario, the remaining 60K entries may service additional 30K SSDP hosts.

To provide the number of additional SSDP hosts that may be supported, the two multicast entries may be reserved for each host. With 60K remaining entries, if the network device 104 allocates all available 60K entries to multicast, the network device 104 may support 30K additional hosts (60K entries divided by two (2) entries per host). In some implementations, additional 20K SSDP hosts may be supported if only 40K multicast entries are allocated (20K additional hosts having 2 entries per host).

After allocating 40K entries for the additional 20K SSDP hosts, there may be 20K entries left unallocated (40K subtracted from 60K). The unallocated 20K entries may be reserved for future allocation or used for other network functions 302 according to the demand of the network functions 302. The implementation of the network device 104 may service additional 20K SSDP hosts. The allocation of hardware resources 314 is balanced in such a way that the remaining free entries are sufficient to manage the multicast requirements of 20K additional SSDP hosts, in addition to the initial 4K hosts supported by the 8K multicast entries.

In a network device not using the elastic configuration, to support an additional 20K SSDP hosts, a cloud provider may procure additional network switches. If one switch may support 4K SSDP hosts, then five additional switches (4K multiplied by five (5) constitutes a total of 20K) may be appropriate to support the additional 20K SSDP hosts. The elastic network configuration of the network device 104 eliminates or substantially reduces the additional capital expenditure by dynamically reallocating the available hardware resources 314 to meet the changing demand without the procurement of additional hardware resources or with minimal procurement of additional hardware resources.

In some implementations, the network device 104 may be configured to provide variations in the allocation of hardware resources 314. As an example, the network device 104 may be configured to allocate more hardware resources 314 to a particular network function (e.g., one of the network functions 302) during peak usage times, and less hardware resources 314 during off-peak times. The dynamic allocation of hardware resources 314 allows the network device 104 to adapt to changes in the demand of the network functions 302, thereby improving efficiency and reducing capital and operational expenditures.

In some implementations, the network device 104 may be configured to allocate hardware resources 314 based on the type of network traffic. For example, the network device 104 may allocate more hardware resources 314 to manage unicast traffic during business hours, and more hardware resources 314 to manage multicast traffic during non-business hours. The dynamic allocation of hardware resources 314 based on traffic type allows the network device 104 to adapt to changes in network traffic patterns, thereby improving network performance and user experience.

In some implementations, the network device 104 may be configured to allocate hardware resources 314 based on a priority of the network functions 302. For example, the network device 104 may allocate more hardware resources 314 to high-priority network functions 302 and less hardware resources 314 to low-priority network functions 302.

The prioritization of network functions may be determined through a combination of predetermined settings and dynamic assessments by the network device 104. In some implementations, the network device 104 can have a set of default priority levels for different network functions 302, based on their typical importance in most network environments. For example, core routing functions may have a higher default priority than logging or telemetry functions.

In some implementations, network administrators may customize the default priority levels during initial configuration or through subsequent management operations. In some implementations, the network device 104, through its active capacity monitor 306, can dynamically adjust priorities based on observed network conditions and usage patterns. For example, if the network device 104 detects a surge in security threats, the network device 104 may temporarily elevate the priority of security-related functions.

The priority of a network function may change based on the current network context or the network device 104 role in the computing system 100. For example, edge devices may prioritize access control functions, while core devices prioritize high-speed routing functions.

In some implementations, if the network device 104 may be aware of SLAs, network device 104 may adjust priorities to ensure that SLA-critical functions maintain the appropriate hardware resources 314. In some implementations, the network device 104 may use machine learning algorithms to learn and adapt function priorities based on long-term network performance and business impact metrics.

In some implementations, a high-priority function may perform core routing (e.g., BGP processing). As an example, a guaranteed minimum of 30 percent of available hardware resources 314 may be allocated to such high-priority function. In some implementations, such high-priority function may scale up to 50 percent of the available hardware resources 314 during peak demands.

In some implementations, a medium-priority function may process ACLs. As an example, a guaranteed minimum of 20 percent of available hardware resources 314 can be allocated to such medium-priority function. In some implementations, such medium-priority function may scale up to 30 percent if higher-priority functions may not need the hardware resources 314.

In some implementations, a low-priority function may perform network statistics collection. As an example, a minimum of five percent of available hardware resources 314 may be allocated to such low-priority function. In some implementations, such low-priority function may scale up to fifteen percent when excess resources are available.

The network device 104 may monitor in real time or near real time usage of the hardware resources 314 and adjusts allocations within the parameters to allow an improved performance of high-priority functions while maintaining operation of lower-priority functions. The dynamic allocation of hardware resources 314 based on priority of the network functions 302 allows the network device 104 to provide high-priority network functions 302 with less impact or no impact by resource constraints, thereby improving network reliability and performance.

In some implementations, the network device 104 may be configured to allocate the hardware resources 314 based on a capacity of the ASIC (or other suitable circuitries). For example, the network device 104 may allocate more hardware resources 314 to network functions 302 for which a greater ASIC capacity may be appropriate, and less hardware resources 314 to network functions for which less ASIC capacity may be appropriate. In some implementations, the network device 104 can include ASIC that have the following characteristics: total memory of 32 MB SRAM; a lookup engine, which is capable of handling up to 1,000,000 entries; and eight parallel packet processing pipelines.

In some implementations, it may be appropriate for the network device 104 to allocate resources for three primary network functions: IP routing, ACLs, and QoS. Based on the ASIC capacity, the network device 104 may allocate the hardware resources 314 in the following manner. Because IP routing typically requires relatively large tables and frequent lookups, benefiting from more memory and lookup entries, 16 MB SRAM (50 percent of total memory); 600,000 lookup entries (60 percent of lookup capacity); and four packet processing pipelines may be allocated to IP routing.

Because ACLs typically require complex rule matching, benefiting from significant memory and lookup resources, 12 MB SRAM (37.5 percent of total memory); 350,000 lookup entries (35 percent of lookup capacity); and three packet processing pipelines may be allocated to the ACLs. Because QoS typically requires less memory and fewer lookups compared to IP routing or ACLs, but still needs dedicated processing power, 4 MB SRAM (12.5 percent of total memory); 50,000 lookup entries (five percent of lookup capacity); and one packet processing pipeline may be allocated to QoS.

In some implementations, the resource allocation system 108 may monitor in real time or near real time the usage of the above allocations. If the network device 104 may detect that the ACL function is consistently underutilizing its resources while the IP routing function is constrained, the resource allocation system 108 may dynamically adjust the allocation as following. The ACL allocation may decrease to 8 MB SRAM and 250,000 lookup entries. The IP Routing allocation may increase to 20 MB SRAM and 700,000 lookup entries. The dynamic allocation of hardware resources 314 based on ASIC capacity allows the network device 104 to improve the use of ASIC resources, thereby improving network performance and efficiency.

In some implementations, the network device 104 may be configured to allocate hardware resources 314 based on a capacity of the logical tables. For example, the network device 104 may allocate more hardware resources 314 to network functions 302 for which larger logical tables may be appropriate, and less hardware resources 314 to network functions 302 for which smaller logical tables may be appropriate. As an example, the network device 104 may manage the following network functions and their associated logical tables: a MAC address table (e.g., for layer 2 switching), an IP routing table (e.g., for layer 3 routing), and ACL table.

In some implementations, initial logical table configurations may be following: the MAC address table may be configured for up to 32,000 entries; the IP routing table may be configured for up to 100,000 entries; and the ACL table may be configured for up to 5,000 entries. The available hardware resources may include 64 MB of total memory and 128,000 TCAM Entries.

Based on the logical table capacities, the network device 104 may initially allocate the hardware resources 314 as follows. 12 MB memory and 32,000 TCAM entries may be allocated to the MAC address table. While MAC address lookups typically use exact matching and could be implemented with standard memory, some switching features (like MAC-based ACLs or QoS) may benefit from relatively fast parallel lookup capabilities of the TCAM. The allocation matches the logical table size to support such features.

In some implementations, 48 MB memory and 90,000 TCAM entries may be allocated to the IP routing table. A relatively large allocation may be due to the high capacity of the IP routing logical table. In some implementations, 4 MB memory and 6,000 TCAM entries may be allocated to the ACL table. A relatively smaller allocation may be due to the smaller logical table size.

As the network operates, the active capacity monitor 306 may observe the following: the MAC address table is consistently near capacity (e.g., 30,000 entries may be used); the IP routing table is underutilized (e.g., only 40,000 entries may be used); and the ACL table may operate at its capacity level and may cause performance issues.

Based on such observations, the resource allocation system 108 may dynamically reallocate the resources. As an example, the MAC address table may have an increased allocation to 16 MB memory and 40,000 TCAM entries, the logical table capacity may be increased to 40,000 entries. In some implementations, the IP routing table may have a decreased allocation to 32 MB memory and 60,000 TCAM entries, the logical table capacity may remain at 100,000 entries, but the hardware resources 314 are reduced. In some implementations, the ACL table may have an increased allocation to 16 MB memory and 28,000 TCAM entries, the logical table capacity may be increased to 20,000 entries.

In some implementations, the above reallocation allows the network device 104 to accommodate growth in the MAC address table, free up underutilized hardware resources 314 from the IP routing table, and resolve performance issues with the ACL table by increasing its capacity. The dynamic allocation of hardware resources 314 based on logical table capacity allows the network device 104 to improve the use of logical table resources, thereby improving network performance and efficiency.

In some implementations, the network device 104 may be configured to allocate hardware resources 314 based on a capacity of the hash tables in the ASIC. For example, the network device 104 may allocate more hardware resources 314 to network functions 302 for which greater hash tables may be appropriate, and less hardware resources 314 to network functions 302 for which smaller hash tables may be appropriate.

In some implementations, the network device 104 may have ASICs that support multiple hash tables of various sizes. The network device 104 may need to allocate resources for three tables corresponding to the following network functions: a layer 2 forwarding function (e.g., corresponding to a MAC address table), an IPv4 host function (e.g., corresponding to an IPv4 host route table), and a network address translation (NAT) session function (e.g., corresponding to a NAT session table). In some implementations, available hash table resources in the ASIC may include a total capacity of 384K entries, e.g., 2×64K entry hash tables; 4×32K entry hash tables; and 8×16K entry hash tables.

In some implementations, based on expected usage and the hash table capacities available in the ASIC, the network device 104 may initially allocate resources in the following manner. Because large enterprise networks can have tens of thousands of MAC addresses to track, 1×64K entry hash table may be allocated to the layer 2 forwarding (e.g., the MAC address table).

In some implementations, 2×32K entry hash tables (total 64K entries) may be allocated to the IPv4 host route table because direct host routes are common in data center environments and can grow to large numbers. In some implementations, 2×32K entry hash tables (total 64K entries) can be allocated to the NAT session table because NAT sessions can be numerous in gateway deployments, requiring substantial table space. In some implementations, 1×64K table and 8×16K tables (total 192K entries) may remain unallocated.

In some implementations, as the network operates, the active capacity monitor 306 may observe the following: the layer 2 forwarding table is underutilized, not exceeding 30K entries; the IPv4 host route table may be frequently at its capacity, causing new route installations to fail; and the NAT session table may be adequately sized for current usage.

Based on the above observations, the resource allocation system 108 may dynamically reallocate the resources. In some implementations, the layer 2 forwarding (e.g., the MAC address table) may have a new allocation of 2×16K entry hash tables (total 32K entries) and 1×64K entry hash table may be freed up. The IPv4 host route table may have a new allocation of 1×64K entry hash table (freed from level 2 forwarding) and the original 2×32K hash tables. The new total capacity of the IPv4 host route table may be 128K entries. In some implementations, the NAT session table may remain unchanged having allocation of 2×32K entry hash tables (64K entries). The 6×16K tables (96K entries) may remain unallocated.

The above reallocation allows the resource allocation system 108 to relatively right-size the layer 2 forwarding table to its observed usage; double the capacity of the IPv4 host route table, addressing the capacity issues; maintain adequate resources for NAT sessions; and keep some hash table resources in reserve for future needs or other network functions 302. The dynamic allocation of hardware resources 314 based on hash table capacity allows the network device 104 to improve the use of hash table resources, thereby improving network performance and efficiency.

The thin provisioning engine 304, the active capacity monitor 306, and the thick provisioning engine 308 may provide in-service elasticity, allowing the network device 104 to be responsive and adaptive to varying demands without the rigidity of static resource allocation. In-service elasticity of the network device 104 may be utilized in cloud environments and other dynamic networking scenarios where traffic patterns may be unpredictable and resource demands may fluctuate relatively rapidly.

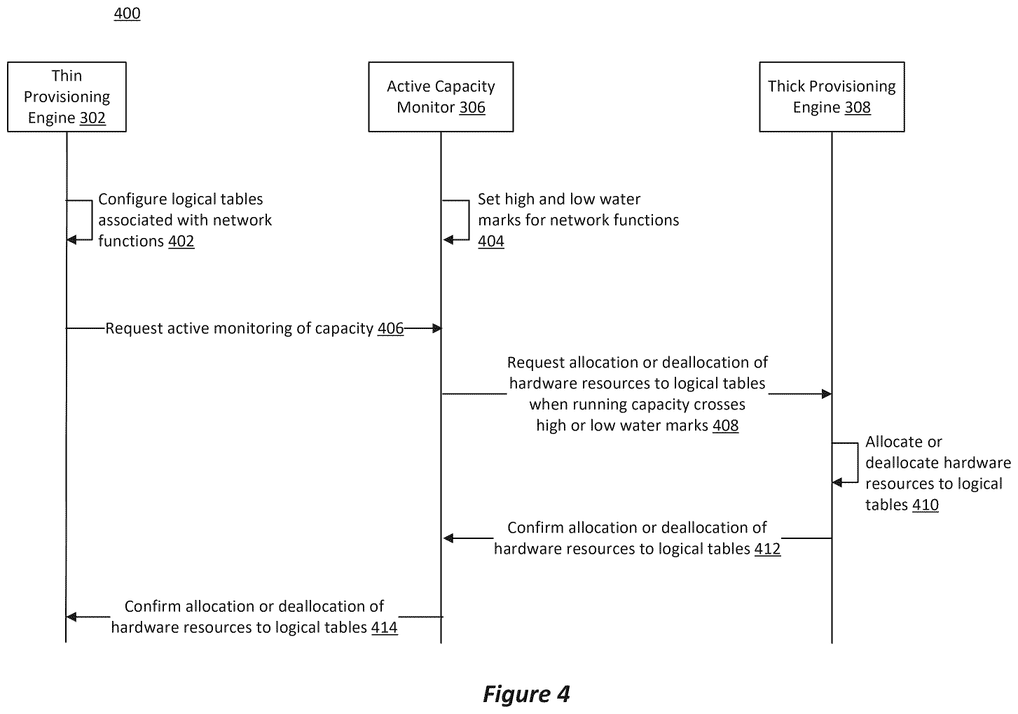

FIG. 4 illustrates an example method for allocating the hardware resources 314 for the network functions 302 of the network device 104, according to some implementations. More specifically, FIG. 4 illustrates a flowchart showing a process of managing hardware resources 314 by the network device 104. In some implementations, the resource allocation system 108 provides the dynamic allocation of hardware resources 314 by the network device 104.

The process of managing hardware resources may begin with the thin provisioning engine 304 initiating the configuration of logical tables associated with the network functions 302. The network functions 302 are the various tasks or services that the network device 104 may perform. Examples of the network functions 302 may include MAC address lookup, IP routing, multicast group management, access control lists (ACLs), and QoS functions.

In some implementations, the logical tables may be configured based on different criteria, such as the priority of the network functions 302, the expected load on the network functions 302, or the historical usage patterns of the network functions 302. The logical tables, such as those associated with layer 2 functions (e.g., MAC address lookup), layer 3 functions (e.g., IP routing), and layer 4 functions (e.g., QoS), may be configured in the operating system memory of the network device 104 and may be independent of the underlying ASIC resources.

In some implementations, thin provisioning may include identification of the device persona. Based on the device persona, a configurable profile may be selected, where the configurable profile may facilitate the configuration of logical tables. As an example, the logical tables can be scaled, e.g., the configurable profile may assign a maximum scale for each logical table, defining the scope of hardware resources 314 available for the associated network functions 302.

In some implementations, the device persona may transfer information through the network functions 302 to logical tables (which may be managed by the thin provisioning engine 304), monitoring plugins, and to hardware resources 314 (which may be managed by the thick provisioning engine 308). As an example, the process of assigning the hardware resources 314 may include the device persona communicating to the network functions 302, monitoring usage of the hardware resources 314, and provisioning the hardware resources 314 accordingly to provide efficient and dynamic network operation.

The active capacity monitor 306 may observe the demand of the network functions 302 and utilize the thresholds to make informed decisions about when to allocate or deallocate physical resources from the hardware resources 314 to the logical tables. The dynamic allocation is facilitated by the thick provisioning engine 308, which manages the actual RAM allocation in the ASIC resources based on the current demand.

Thick provisioning in the network device 104 may include monitoring the current demand for the hardware resources 314. The active capacity monitor 306 may set the high and low watermarks for the network functions 302 through the watermark setting function 404. The watermarks are thresholds that facilitate the allocation and deallocation of resources. The active capacity monitor 306 may monitor in real time or near real time utilization of the hardware resources 314 by the network functions 302. The active capacity monitor 306 may send a monitoring request signal 406 to actively monitor the capacity of the hardware resources 314.

As the demand of the network functions 302 fluctuates, the active capacity monitor 306 sends a resource adjustment request 408 to the thick provisioning engine 308, which may be configured to perform the actual allocation or deallocation of physical resources from the hardware resources 314 to the logical tables. The thick provisioning engine 308 may adjust the allocation or deallocation of hardware resources in response to the signals received from the active capacity monitor 306. Based on the demand of the network functions 302, hardware resources 314 are allocated or deallocated to and from the logical tables in increments. Plugins may facilitate an improved decision of allocating or deallocating the hardware resources 314 to the logical tables by providing criteria such as time of day or AI predictions. The thick provisioning engine 308 may adjust the allocation of resources as demand changes in real time or near real time. The process of allocation and deallocation provides dynamic adjustment of hardware resources 314 to meet the demand of the network functions 302 without causing substantial downtime.

When allocation or deallocation of the hardware resources 314 is completed, the thick provisioning engine 308 sends an adjustment confirmation signal 412 to the active capacity monitor 306. The adjustment confirmation signal 412 provides the network device 104 with maintenance of an accurate and up-to-date view of resource utilization, providing efficient management of the hardware resources 314.

The method 400 concludes with the thin provisioning engine 304 receiving confirmation signal 414 of the allocation or deallocation of hardware resources 314, providing the logical tables with an appropriate scaling to meet the current demand of the network functions 302. The dynamic and responsive configuration of the network device 104 provides the network device 104 adaptability to changing network conditions without service interruption or with minimal service interruption. The resource allocation system 108 improves resource utilization and reduce the potential for inefficiencies.

By utilizing thin provisioning, active capacity monitoring, and thick provisioning, the network device 104 may indicate that the network device 104 may support a larger scale of operations or handle more network traffic than what is actively being utilized at a certain moment. The network device 104 uses logical tables that represent a potential capacity without the immediate upfront use of additional physical hardware resources 314, allowing the network device 104 to dynamically adjust to changing demands as they increase or decrease. The approach disclosed herein for adjusting the hardware resources 314 allows for a flexible and efficient use of the hardware resources 314, providing the network device 104 adaptability to the fluctuating demands of the network functions 302 without the initial over-provisioning of the hardware resources 314.

In some implementations, the method 400 of FIG. 4 may manage resources in different types of network systems. For example, the method 400 may be applied to manage resources in wired networks, wireless networks, cellular networks, or hybrid networks. The method 400 may be applied to manage resources in different network architectures, such as client-server architectures, peer-to-peer architectures, or cloud-based architectures.

In some implementations, the method 400 outlined in FIG. 4 provides a dynamic, in-service approach to network resource management. By creating the logical tables, allocating the hardware resources 314 based on the demand of the network functions 302, and dynamically adjusting resource allocation in response to the demand of the network functions 302, the method 400 allows for efficient and adaptable network operation. The method 400 addresses the limitations of static network devices and provides a more efficient solution for managing hardware resources 314.

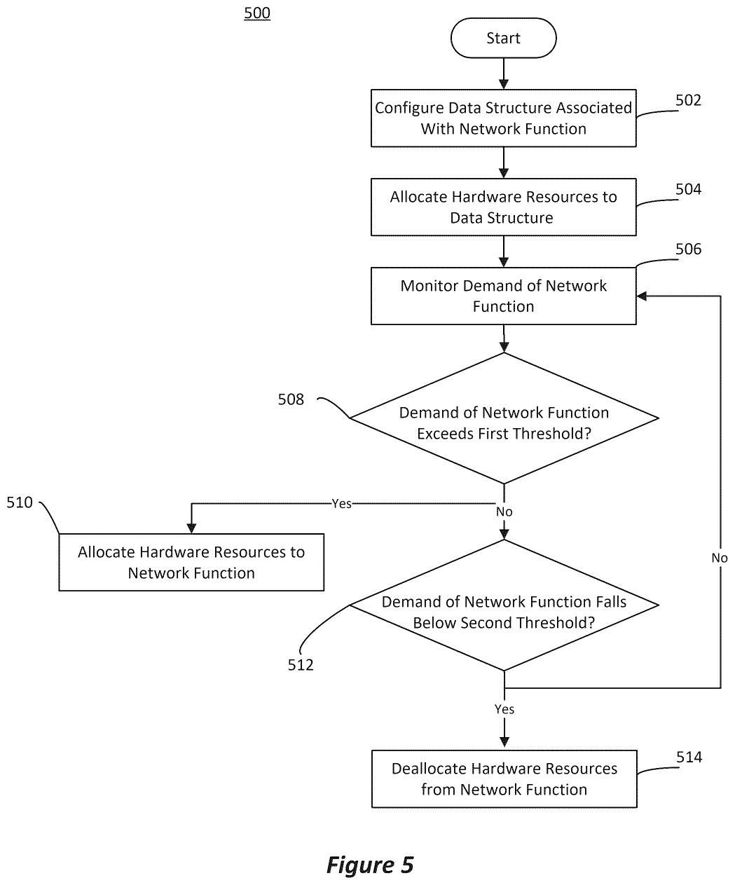

FIG. 5 illustrates an example method for allocating the hardware resources 314 for the network functions 302 of the network device 104, according to some implementations. More specifically, FIG. 5 illustrates a flowchart 500 that outlines a method for managing network resources using the network device 104. The process begins with configuration of the data structures 310 (e.g., logical tables) associated with the network function, e.g., one of the network functions 302 (step 502). Step 502 includes setting a virtual representation of a capacity of the network function in the network device software.

In some implementations, the network functions 302 may include layer 2 functions, layer 3 functions, and layer 4 functions. In some implementations, the network device 104 may include security functions in addition to layer 2 functions, layer 3 functions, and layer 4 functions. In some implementations, the layer 2 functions may include unicast bridging and IGMP/MLD Snoop, the layer 3 functions may include OSPF, PIM SM, PIM BIDIR, and BGP, and the layer 4 functions may include IP FLOW and/or telemetry.

In some implementations, the thin provisioning engine 304 may configure logical tables based on the network demand (e.g., the demand of the network functions 302). The thin provisioning engine 304 facilitates a dynamic and efficient allocation of hardware resources 314 in response to the current network conditions. The logical tables serve as placeholders in the network device 104 that define the maximum potential resource allocation for the various network functions 302 without upfront consumption of physical hardware resources 314.

Step 502 for configuring the data structures 310 may be based on a configurable profile associated with a device persona, as described in the context of the thin provisioning engine 304 in FIG. 3. In some implementations, the device persona may be determined based on the type of the network device 104 (e.g., router, switch, access point), the role of the network device 104 within the network (e.g., edge device, core device), or the specific network functions 302 supported by the network device 104.

The present disclosure describes a plugin-based configuration for the active capacity monitor 306. In some implementations, each plugin can be configured to adjust the allocation of the hardware resources 314 based on a specific criterion. The specific criteria may include services based on time of day, AI driven predictive models, subscription based services (e.g., service agreement), and other suitable criteria. In some implementations, each criterion (or theme of the plugin) may facilitate the decision of when to allocate and de-allocate the hardware slices for the various logical tables.

Following the configuration of the data structures 310, the network device 104, which includes a processor 202 and memory 206 (FIG. 2), allocates or deallocates the hardware resources 314 to the data structures 310 based on the current demand (step 504). Allocation or deallocation in step 504 controls at least partially the hardware resource 314, which may include hash tables in the ASIC.

The thin provisioning engine 304 may configure logical or virtual tables that represent the addressable scale for the network functions 302, as shown in FIG. 3. The logical tables, associated with the network function (e.g., one of the network functions 302), are not pre-allocated up front with all hardware resources 314, allowing for a flexible and scalable approach to resource management. The thin provisioning engine 304 provides availability of the network device 104 to be present with a larger capacity to the network control plane (or control layer) than what is currently allocated with respect to the hardware resources 314. The thin provisioning engine 304 allows the network device 104 to adapt to the demand of one or more network functions 302 dynamically.

The network device 104 may actively monitor the demand of the network function, e.g., the demand of one of the network functions 302 (step 506) using the active capacity monitor 306, which monitors the network resource utilization in real time or in near real time and adjusts the allocation of the hardware resources 314 accordingly. The monitoring process is at least partially based on the software components 312 of the network configuration, which may include various plugins that provide intelligence and adaptability to the resource allocation system 108.

The thick provisioning engine 308 dynamically allocates or deallocates actual hardware resources from the hardware resource 314 to the logical tables as demand increases or decreases, respectively. As illustrated in FIGS. 3 and 4, the thick provisioning engine 308 manages the physical table space in the ASIC based on the current demand, providing adaptability to the network device 104 with respect to changing traffic patterns without substantial service interruption.

The active capacity monitor 306 may monitor in real time or near real time the demand of the network functions 302 and the utilization of logical tables to determine when to allocate or deallocate the hardware resources 314. The allocation of the hardware resources 314 may be dynamically adjusted in response to changes in the demand of the network functions 302. The process shown in FIG. 5 (specifically, steps 506 through 514) illustrates the active capacity monitor 306 adjusting the allocation of resources from the hardware resources 314 to maintain an efficient use of hardware resources 314.

The flowchart includes decision blocks 508 and 512. The decision blocks 508 and 512 are based on the high and low watermarks, respectively, set by the active capacity monitor 306, as outlined in FIG. 4. If the demand of the network function (e.g., one of the network functions 302) exceeds the first threshold (positive branch of the decision block 508), the network device 104 allocates additional hardware resources 314 to the network function, e.g., one of the network functions 302 (step 510). Otherwise, following a negative branch of the decision block 508, the method reaches the decision block 512 to determine the demand of the network function (e.g., one of the network functions 302) with respect to the second threshold. If the demand of the network function falls below the second threshold (positive branch of the decision block 512), the network device 104 deallocates hardware resources 314 from the network function, e.g., one of the network functions 302 (step 514). Otherwise, following a negative branch of the decision block 512, the method loops back to step 506 to continue monitoring the demand of the network function.

The flowchart 500 shows the dynamic and responsive nature of the network device 104 providing adaptability to the network device 104 to adapt to changing network conditions without substantial service interruption. The method in flowchart 500 leverages the components of the network device 104, including the processor 202, memory 206, and resource allocation system 108, which improve resource utilization and reduce the potential for inefficiencies. The dynamic adjustment of resources provides the network device 104 adaptability to changes in the demand of the network functions 302, thereby improving efficiency and reducing capital and operational expenditures.

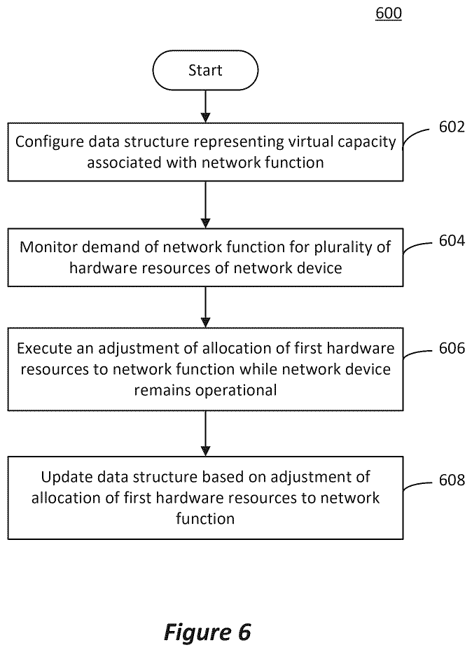

FIG. 6 illustrates an example method for allocating hardware resources for the network functions 302 of the network device 104, according to some implementations. More specifically, FIG. 6 is a flowchart of an example process 600, where one or more process blocks of FIG. 6 may be performed by the network device 104.

As shown in FIG. 6, process 600 may include configuring data structures 310 representing a virtual capacity associated with a network function, e.g., one of the network functions 302 (block 602). In some implementations, the virtual capacity can correspond to an allocation of first hardware resources 314 of a plurality of hardware resources of the network device 104 to the network functions 302. In some implementations, process 600 may include monitoring a network demand (e.g., a demand of the network functions 302) for the plurality of hardware resources 314 of the network device 104 (block 604). In some implementations, process 600 may include executing an adjustment of the allocation of the first hardware resources 314 to the network functions 302 while the network device 104 remains operational (block 606). In some implementations, executing an adjustment of the allocation of the first hardware resources 314 to the network functions 302 can be at least partially based on a capacity allocation rule and the demand of the network functions 302. In some implementations, process 600 may include updating the data structures 310 based on the adjustment of the allocation of the first hardware resources 314 to the network function, e.g., one of the network functions 302 (block 608). For example, the network device 104 may configure data structures 310 representing a virtual capacity associated with a network function (e.g., one of the network functions 302).

Process 600 may include additional implementations, such as any single implementation or any combination of implementations described below and/or in connection with one or more other processes described elsewhere herein. In a first implementation, executing the adjustment of the allocation of the first hardware resources 314 to the network functions 302 may include allocating to the network functions 302, while the network device 104 remains operational, second hardware resources 314 of the plurality of hardware resources 314, at least partially based on the capacity allocation rule and the demand of the network functions 302. In some implementations, updating the data structures 310 can be based on the adjustment of the allocation of the first hardware resources 314 to the network functions 302 may include updating the data structures 310 based on the second hardware resources 314 being allocated to the network functions 302.

In a second implementation, alone or in combination with the first implementation, the capacity allocation rule may include allocating the second hardware resources 314 to the network functions 302 in response to the demand of the network functions 302 for the plurality of hardware resources 314 exceeding a resource allocation threshold.

In a third implementation, alone or in combination with the first and second implementation, executing the adjustment of the allocation of the first hardware resources 314 to the network functions 302 may include deallocating from the network functions 302, while the network device 104 remains operational, third hardware resources 314, at least partially based on the capacity allocation rule and the demand of the network functions 302. In some implementations, updating the data structures 310 can be based on the adjustment of the allocation of the first hardware resources 314 to the network functions 302 may include updating the data structures 310 based on the third hardware resources 314 being deallocated from the network functions 302.

In a fourth implementation, alone or in combination with one or more of the first through third implementations, the capacity allocation rule may include deallocating the third hardware resources 314 from the network functions 302 in response to the demand of the network functions 302 for the plurality of hardware resources 314 falling below a resource allocation threshold.

In some implementations, capacity allocation rules may be based on factors such as current utilization, growth rates, time-based patterns, function priorities, predictive analytics, and combinations thereof. As an example, a threshold-based allocation rule may be that if utilization exceeds 80 percent of a current capacity, then the resource allocation system 108 increases allocation by 25 percent of the current capacity. As an example, when the current capacity is 10,000 entries and the current utilization is 8,100 entries (81 percent), then it is appropriate for the capacity is increased by 2,500 entries to 12,500 total entries.

In some implementations, a rate-based allocation rule may be that if the rate of a new entry creation exceeds 1,000 per minute for five consecutive minutes, then it is appropriate to double the current allocation. As an example, if the current capacity is 50,000 entries and the observed rate is 1,200 new entries per minute for five minutes, then it is appropriate for the capacity to be increased to 100,000 entries.

In some implementations, a time-of-day allocation rule may be that between 9 AM and 5 PM on weekdays, it is appropriate to maintain a minimum of 50 percent extra capacity above current utilization. As an example, if the current utilization at 2 PM may be 15,000 entries, then it is appropriate for the total capacity to be at least 22,500 entries (e.g., 15,000 multiplied by 1.5)

In some implementations, a deallocation rule with hysteresis may be that if utilization falls below 30 percent for one hour, then it is appropriate to reduce capacity by 20 percent, but not below the initial baseline capacity. As an example, if the current capacity is 20,000 entries and utilization is 5,000 entries (e.g., 25 percent) for over an hour and the initial baseline is 10,000 entries, then it is appropriate to reduce capacity to 16,000 entries (e.g., 20,000 multiplied by 0.8)

In some implementations, a function priority-based rule can be such that for high-priority functions, it is appropriate to allocate the hardware resources 314 to maintain at least 25 percent free capacity. As an example, if a high-priority function current usage may be 7,500 entries, then it may be appropriate that the total allocation is at least 10,000 entries (e.g., 7,500 divided by 0.75)

In some implementations, a multi-factor allocation rule may be that if utilization exceeds 70 percent and the growth rate is over 10 percent per hour, then it is appropriate to increase capacity by the larger of 50 percent or the projected 2-hour growth. As an example, if the current capacity is 100,000 entries, the current utilization is 75,000 entries (e.g., 75 percent), the growth rate is 15 percent per hour, and the projected 2-hour growth is 22,500 entries, then it is appropriate to increase capacity by 50,000 entries (e.g., 50 percent being larger than the projected growth)

In some implementations, a predictive allocation rule may be to allocate capacity based on the maximum of current utilization, 7-day average peak, or AI-predicted peak for the next 24 hours. As an example, if the current utilization is 50,000 entries, the 7-day average peak is 65,000 entries; and the AI-predicted peak is 70,000 entries, then it is appropriate to allocate capacity for 70,000 entries.

In some implementations, a resource balancing rule may be that if one table exceeds 90 percent capacity while another table is below 30 percent, then it is appropriate to reallocate up to 20 percent from the underutilized table to the highly utilized table. As an example, if a first table used 95 percent of 10,000 entries and a second table used 25 percent of 20,000 entries, then it may be appropriate to move 4,000 entry capacity from the second table to the first table.

Although FIG. 6 shows example blocks of process 600, in some implementations, process 600 may include additional blocks, fewer blocks, different blocks, or differently arranged blocks than those depicted in FIG. 6. Additionally or alternatively, two or more of the blocks of process 600 may be performed in parallel.

As discussed above, the network device 104 provides a dynamic, in-service elastic network configuration that may adapt to changes in the demand of the network functions 302. The in-service elastic network configuration may reduce CapEx and OpEx by efficiently managing network resources. The resource allocation system 108 for allocation and deallocation of hardware resources 314 is “in-service,” meaning the resource allocation system 108 may adjust hardware resources 314 without causing substantial network downtime. The methods of network management disclosed herein address the limitations of static systems and provide a more efficient and adaptable solution.

In some implementations, the dynamic in-service elastic network configuration of the network device 104 may benefit cloud computing environments and data centers. In some implementations, the network device 104 configured for dynamic, in-service allocation of the hardware resources 314 may be used in multi-tenant network environments, and may improve resource isolation and allocation in those multi-tenant network environments.

In some implementations, the network device 104 may improve the ability of edge devices to handle the diverse and fluctuating demands of Internet of the IoT networks. For 5G and future generations, dynamic resource allocation of the network device 104 may complement network slicing technologies. As an example, the network device 104 can potentially provide efficient and flexible allocation of the hardware resources 314 across different network slices. In some implementations, an ability to quickly allocate the hardware resources 314 of the network device 104 may support requirements of ultra-reliable low latency communication (URLLC) applications. As an example, the network device may potentially improve the reliability and responsiveness of such URLLC communications.

In some implementations, the network device 104 may manage a relatively large number of connections in massive machine type communications (mMTC) scenarios. As an example, the network device 104 may potentially improve ability of the network 102 to handle sporadic traffic from the client devices 106 and/or data transmission in short signal bursts.

In some implementations, the network device 104 may improve software-defined networking (SDN) or network function virtualization (NFV) environments. As an example, dynamic network functions of the network device 104 may provide efficient allocation of the hardware resources 314 to virtualized network functions 302. In some implementations, the network device 104 can potentially improve the performance and scalability of NFV infrastructures. In some implementations, the network device 104 may improve programmable networks. As an example, providing dynamic allocation of the hardware resources 314 may complement the flexibility of SDN, potentially improving an ability of SDN controllers to improve performance of the network 102.

In some implementations, the efficient utilization of the hardware resources 314 offered by the network device 104 may contribute to green networking initiatives. As an example, energy efficiency provided by dynamic resource allocation may lead to efficient use of the hardware resources 314, potentially reducing energy consumption. In some implementations, the network device 104 can potentially provide selective powering down of unused hardware resources 314. In some implementations, lifespan of the hardware resources 314 may be extended by efficient resource utilization. As an example, the network device 104 can potentially reduce electronic waste associated with frequent upgrades of the hardware resources 314.

Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. Steps may operate in an operating system environment or as stand-alone routines occupying all or a substantial part of the system processing.

While this disclosure has been described with reference to illustrative implementations, this description is not intended to be construed in a limiting sense. Various modifications and combinations of the illustrative implementations, as well as other implementations of the disclosure, will be apparent to persons skilled in the art upon reference to the description. It is therefore intended that the appended claims encompass any such modifications or implementations.

What is claimed is:

1. A network device, comprising:
one or more processors; and
a non-transitory computer-readable medium storing programming for execution by the one or more processors, the programming comprising instructions to:
configure a data structure representing a virtual capacity associated with a network function, the virtual capacity corresponding to an allocation of first hardware resources of a plurality of hardware resources of the network device to the network function;
monitor a demand of the network function for the plurality of hardware resources of the network device;
execute an adjustment of the allocation of the first hardware resources to the network function, while the network device remains operational, at least partially based on a capacity allocation rule and the demand of the network function; and
update the data structure based on the adjustment of the allocation of the first hardware resources to the network function.

2. The network device of claim 1, wherein:
executing the adjustment of the allocation of the first hardware resources to the network function comprises allocating, to the network function while the network device remains operational, second hardware resources of the plurality of hardware resources at least partially based on the capacity allocation rule and the demand of the network function; and
updating the data structure based on the adjustment of the allocation of the first hardware resources to the network function comprises updating the data structure based on the second hardware resources being allocated to the network function.

3. The network device of claim 2, wherein the capacity allocation rule comprises allocating the second hardware resources to the network function in response to the demand of the network function for the plurality of hardware resources exceeding a resource allocation threshold.

4. The network device of claim 1, wherein:
executing the adjustment of the allocation of the first hardware resources to the network function comprises deallocating, from the network function while the network device remains operational, third hardware resources at least partially based on the capacity allocation rule and the demand of the network function; and
updating the data structure based on the adjustment of the allocation of the first hardware resources to the network function comprises updating the data structure based on the third hardware resources being deallocated from the network function.

5. The network device of claim 4, wherein the capacity allocation rule comprises deallocating the third hardware resources from the network function in response to the demand of the network function for the plurality of hardware resources falling below a resource allocation threshold.

6. The network device of claim 1, wherein the data structure comprises a first resource allocation threshold and a second resource allocation threshold.

7. The network device of claim 6, wherein the programming further comprises instructions to adjust one or more of the first resource allocation threshold or the second resource allocation threshold based on the demand of the network function.

8. The network device of claim 1, wherein the data structure comprises a logical table.

9. The network device of claim 1, wherein the hardware resources comprise hash tables.

10. The network device of claim 1, wherein the programming further comprising instructions to execute the adjustment of the allocation of the first hardware resources of the plurality of hardware resources at least partially based on one or more of:
a configuration of the device; or
a configuration of a network.

11. The network device of claim 10, wherein:
the programming further comprises instructions to execute the adjustment of the allocation of the first hardware resources of the plurality of hardware resources at least partially based on the configuration of the network; and
the configuration of the network is at least partially based on at least one of a period of time, a service agreement, or a predictive model for identifying patterns of the demand of the network function.

12. The network device of claim 1, wherein:
the plurality of hardware resources comprises a first portion and a second portion, a current allocation of hardware resources to the network function being from the first portion; and
the programming further comprises instructions to reserve hardware resources of the second portion of the plurality of hardware resources, wherein the network device is configured to use the hardware resources of the second portion of the plurality of hardware resources in response to the first portion of the plurality of hardware resources not being available for allocation, and wherein at least a subset of the second portion of the plurality of hardware resources is configured to be inactive for a lookup operation in response to a reorganization operation.

13. A method, comprising:
configuring a data structure representing a virtual capacity associated with a network function, the virtual capacity corresponding to an allocation of first hardware resources of a plurality of hardware resources of a network device to the network function;
monitoring a demand of the network function for the plurality of hardware resources of the network device;
executing an adjustment of the allocation of the first hardware resources to the network function, while the network device remains operational, at least partially based on a capacity allocation rule and the demand of the network function; and
updating the data structure based on the adjustment of the allocation of the first hardware resources to the network function.

14. The method of claim 13, wherein:
executing the adjustment of the allocation of the first hardware resources to the network function comprises allocating, to the network function while the network device remains operational, second hardware resources of the plurality of hardware resources at least partially based on the capacity allocation rule and the demand of the network function; and
updating the data structure based on the adjustment of the allocation of the first hardware resources to the network function comprises updating the data structure based on the second hardware resources being allocated to the network function.

15. The method of claim 14, wherein the capacity allocation rule comprises allocating the second hardware resources to the network function in response to the demand of the network function for the plurality of hardware resources exceeding a resource allocation threshold.

16. The method of claim 13, wherein:
executing the adjustment of the allocation of the first hardware resources to the network function comprises deallocating, from the network function while the network device remains operational, third hardware resources at least partially based on the capacity allocation rule and the demand of the network function; and
updating the data structure based on the adjustment of the allocation of the first hardware resources to the network function comprises updating the data structure based on the third hardware resources being deallocated from the network function.

17. The method of claim 16, wherein the capacity allocation rule comprises deallocating the third hardware resources from the network function in response to the demand of the network function for the plurality of hardware resources falling below a resource allocation threshold.

18. A non-transitory computer-readable medium storing programming for execution by one or more processors, the programming comprising instructions to:
configure a data structure representing a virtual capacity associated with a network function, the virtual capacity corresponding to an allocation of first hardware resources of a plurality of hardware resources of a network device to the network function;
monitor a demand of the network function for the plurality of hardware resources of the network device;
execute an adjustment of the allocation of the first hardware resources to the network function, while the network device remains operational, at least partially based on a capacity allocation rule and the demand of the network function; and
update the data structure based on the adjustment of the allocation of the first hardware resources to the network function.

19. The non-transitory computer-readable medium of claim 18, wherein:
executing the adjustment of the allocation of the first hardware resources to the network function comprises allocating, to the network function while the network device remains operational, second hardware resources of the plurality of hardware resources at least partially based on the capacity allocation rule and the demand of the network function; and
updating the data structure based on the adjustment of the allocation of the first hardware resources to the network function comprises updating the data structure based on the second hardware resources being allocated to the network function.

20. The non-transitory computer-readable medium of claim 18, wherein:
executing the adjustment of the allocation of the first hardware resources to the network function comprises deallocating, from the network function while the network device remains operational, third hardware resources at least partially based on the capacity allocation rule and the demand of the network function; and
updating the data structure based on the adjustment of the allocation of the first hardware resources to the network function comprises updating the data structure based on the third hardware resources being deallocated from the network function.
